(19) United States
(12) Patent Application Publication
(10) Pub. No.: US 2024/0373798 A1
(43) Pub. Date: Nov. 14, 2024

(54) MULTI-TRANSITIONAL EMITTER FOR DRIP IRRIGATION

(71) Applicant: The Toro Company, Bloomington, MN (US)

(72) Inventors: William C. Taylor, Jr., El Cajon, CA (US); Brian D. Hu, Escondido, CA (US); Daniel Trinidad, Escondido, CA (US); David S. Martin, Bonita, CA (US); Michael R. Knighton, Lakeside, CA (US)

(73) Assignee: The Toro Company, Bloomington, MN (US)

(21) Appl. No.: 18/693,764

(22) PCT Filed: Oct. 19, 2022
(86) PCT No.: PCT/US2022/047154

§ 371 Date: Mar. 20, 2024

Related U.S. Application Data
(60) Provisional application No. 63/274,757, filed on Nov. 2, 2021.

(51) Int. Cl. A01G 25/02

(52) U.S. Cl. CPC A01G 25/023

(57) ABSTRACT

An emitter (2200) comprises a floor (2201), a first rail (2204a), and a second rail (2202b) defining at least one pressure reducing section (2208) including first opposing features in a first region to provide a first incremental exponent versus flow rate behavior and second opposing features in a second region to provide a second incremental exponent versus flow rate behavior. The first and second incremental exponent versus flow rate behaviors being different and providing a more consistent overall incremental exponent versus flow rate behavior over a pressure range. The emitter (2200) can be connected to a lateral (2227) having an inner wall (2228), at least a portion of the inner wall (126A, 2228) defining a lateral flow path (2229). The first and second rails (2202A) are operatively connected to the inner wall (2228) and the floor (2201) interconnects distal ends of the first and second rails (2202A). The inner wall (2228), the first and second rails (2202A), and the floor (2201) define an emitter flow path (2229).

### CROSS-REFERENCE TO RELATED APPLICATIONS

This application claims the benefit of U.S. Provisional Patent Application Ser. No. 63/274,757, filed Nov. 2, 2021, entitled MULTI-TRANSITIONAL EMITTER FOR DRIP IRRIGATION.

### BACKGROUND

Drip irrigation laterals, hoses or tapes, including emitters, are commonly used in agricultural irrigation to ideally provide predictable amounts of water to the crops under irrigation. The terms lateral, hose and tape may be used interchangeably herein. Determining flow at varying locations throughout a field (pressure differences along laterals, changes in elevation shifting pressures, and/or intentional changes in system pressures to adjust flow rates for crop requirements, water allocation, and/or environmental factors) can be challenging. Drip irrigation manufacturers provide an exponent value to characterize the relationship between flow and pressure for a given emitter (flow=constant×pressure\hat{ }exponent). An irrigation system designer uses the manufacturer's exponent value within their design analysis software when defining the system sizing and lengths of run. Although within the industry, the exponent value is provided as a singular value, in actuality the exponent value varies as a function of flowrate. For example, a typical emitter known within the agricultural irrigation industry as a turbulent flow emitter may state that the exponent for an emitter is 0.50. However, as will be illustrated and explained herein, an emitter with an overall exponent of 0.50 may have incremental exponents ranging from 0.70 at lower flow to 0.40 at transitional flow. Since the irrigation system designer inputs the singular exponent value provided into the system design software, there is a built-in error when the emitter is operating at a flow rate at which the incremental exponent is differing from the overall average exponent value.

For the reasons stated above and for other reasons stated below, which will become apparent to those skilled in the art upon reading and understanding the present specification, there is a need in the art for a multi-transitional emitter for drip irrigation.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, an emitter comprises a floor, a first rail, and a second rail defining at least one pressure reducing section interconnecting an inlet section and an outlet section, the at least one pressure reducing section including first opposing features in a first region configured and arranged to provide a first incremental exponent versus flow rate behavior and second opposing features in a second region configured and arranged to provide a second incremental exponent versus flow rate behavior, the first incremental exponent versus flow rate behavior being different than the second incremental exponent versus flow rate behavior and providing a more consistent overall incremental exponent versus flow rate behavior over a pressure range.

In one embodiment, an irrigation lateral comprises a lateral and an emitter. The lateral has a wall with an inner wall, at least a portion of the inner wall defining a lateral flow path. The emitter has a first rail and a second rail operatively connected to the inner wall and a floor interconnecting distal ends of the first and second rails. The inner wall, the first and second rails, and the floor define an emitter flow path. The emitter comprises a floor, a first rail, and a second rail defining at least one pressure reducing section interconnecting an inlet section and an outlet section, the at least one pressure reducing section including first opposing features in a first region configured and arranged to provide a first incremental exponent versus flow rate behavior and second opposing features in a second region configured and arranged to provide a second incremental exponent versus flow rate behavior, the first incremental exponent versus flow rate behavior being different than the second incremental exponent versus flow rate behavior and providing a more consistent overall incremental exponent versus flow rate behavior over a pressure range.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a graph illustrating a comparison between typical emitter behavior and ideal 0.5 exponent behavior for pressure versus flow;

FIG. 2 is a graph illustrating a comparison of typical emitter behavior versus ideal 0.5 exponent behavior with regard to mid flow versus incremental exponent;

FIG. 3 is a graph illustrating pressure versus flow for an emitter from Competitor B;

FIG. 4 is a graph illustrating mid flow versus incremental exponent for the emitter from Competitor B of FIG. 3;

FIG. 5 is a graph illustrating pressure versus flow for an emitter from Competitor C;

FIG. 6 is a graph illustrating mid flow versus incremental exponent for the emitter from Competitor C of FIG. 5;

FIG. 7 is a graph illustrating pressure versus flow for an emitter from Competitor D;

FIG. 8 is a graph illustrating mid flow versus incremental exponent for the emitter from Competitor D of FIG. 7;

FIG. 9 is an example Moody Diagram;

FIG. 10 is a graph illustrating pressure versus flow for an example emitter equipped with conventional pressure reducing section geometry;

FIG. 11 is a graph illustrating mid flow versus incremental exponent for the example emitter equipped with conventional pressure reducing section geometry of FIG. 10;

FIG. 12 is a schematic view of an emitter with conventional pressure reducing section geometry;

FIG. 13 is a graph illustrating pressure versus flow for four emitter designs, each of which is constructed according to FIG. 12, wherein each of the emitters nominally flows according to labels within FIG. 13 with 8 psi applied pressure;

FIG. 14 is a graph illustrating mid flow versus incremental exponent for each of the four emitters of FIG. 13;

FIG. 15 is a schematic view of an embodiment emitter constructed in accordance with the principles of the present invention;

FIG. 16 is a graph illustrating pressure versus flow for the emitter of FIG. 15 in comparison with both an ideal 0.5 exponent emitter and a conventional emitter with single geometry;

FIG. 17 is a graph illustrating mid flow versus incremental exponent for the emitter of FIG. 15 in comparison with both an ideal 0.5 exponent emitter and a conventional emitter with single geometry;

FIG. 18 is a graph illustrating a comparison among two emitters each having single geometries and one emitter combining the geometries of the two emitters for flow versus incremental exponent;

FIG. 19 is a graph illustrating a comparison among three emitters each having single geometries and one emitter combining the geometries of the three emitters for flow versus incremental exponent;

FIG. 20A is a schematic view of another embodiment emitter constructed in accordance with the principles of the present invention;

FIG. 20B is a graph illustrating a comparison among seven emitters each having single geometries and the emitter of FIG. 20A combining the geometries of the seven emitters for flow versus incremental exponent;

FIG. 21 is a graph illustrating a comparison among the emitters combining the geometries of two, three, and seven geometries of FIGS. 18-20 in comparison with both an ideal 0.5 exponent emitter and a conventional emitter with single geometry;

FIG. 22 illustrates example geometric features to achieve varying transition versus flow local to features;

FIG. 23 is a schematic view of another embodiment emitter constructed in accordance with the principles of the present invention;

FIG. 24 is a graph illustrating a comparison among three emitters each having single geometries and one emitter combining the geometries of the three emitters of FIG. 23 for flow versus incremental exponent;

FIG. 25 is a graph illustrating a comparison among the emitter of FIG. 23, an ideal 0.5 exponent behavior, and a conventional emitter;

FIG. 26 illustrates example geometries for features of the emitter of FIG. 23;

FIG. 27 is a schematic view of another embodiment emitter constructed in accordance with the principles of the present invention;

FIG. 28 is a graph illustrating a comparison among three emitters each having single geometries and one emitter combining the geometries of the three emitters of FIG. 27 for flow versus incremental exponent;

FIG. 29 is a graph illustrating a comparison among the emitter of FIG. 27, an ideal 0.5 exponent behavior, and a conventional emitter;

FIG. 30 illustrates example geometries for features of the emitter of FIG. 27;

FIG. 31 is a schematic view of another embodiment emitter constructed in accordance with the principles of the present invention;

FIG. 32 is a graph illustrating a comparison among three emitters each having single geometries and one emitter combining the geometries of the three emitters of FIG. 31 for flow versus incremental exponent;

FIG. 33 is a graph illustrating a comparison among the emitter of FIG. 31, an ideal 0.5 exponent behavior, and a conventional emitter;

FIG. 34 illustrates example geometries for features of the emitter of FIG. 31;

FIG. 35 is a schematic view of another embodiment emitter constructed in accordance with the principles of the present invention;

FIG. 36 is a graph illustrating a comparison among three emitters each having single geometries and one emitter combining the geometries of the three emitters of FIG. 35 for flow versus incremental exponent;

FIG. 37 is a graph illustrating a comparison among the emitter of FIG. 35, an ideal 0.5 exponent behavior, and a conventional emitter;

FIG. 38 illustrates example geometries for features of the emitter of FIG. 35;

FIG. 39 is a schematic view of another embodiment emitter constructed in accordance with the principles of the present invention;

FIG. 40 is a schematic view of another embodiment emitter constructed in accordance with the principles of the present invention;

FIG. 41 is a schematic view of another embodiment emitter constructed in accordance with the principles of the present invention;

FIG. 42 is a schematic view of another embodiment emitter constructed in accordance with the principles of the present invention;

FIG. 43 is a schematic view of another embodiment emitter constructed in accordance with the principles of the present invention;

FIG. 44 is a schematic view of another embodiment emitter constructed in accordance with the principles of the present invention;

FIG. 45 is a schematic view of a portion of a pressure reducing section of another embodiment emitter constructed in accordance with the principles of the present invention;

FIG. 46 is a schematic view of a portion of a pressure reducing section of another embodiment emitter constructed in accordance with the principles of the present invention;

FIG. 47 is a schematic view of a portion of a pressure reducing section of another embodiment emitter constructed in accordance with the principles of the present invention;

FIG. 48 is a schematic view of a portion of a pressure reducing section of another embodiment emitter constructed in accordance with the principles of the present invention;

FIG. 49 is a schematic view of a portion of a pressure reducing section of another embodiment emitter constructed in accordance with the principles of the present invention;

FIG. 50 is a cross sectional view of an example emitter;

FIG. 51 is a view showing the emitter of FIG. 50 operatively connected to an irrigation lateral;

FIG. 52 is a schematic view of a portion of an embodiment emitter constructed in accordance with the principles of the present invention;

FIG. 53A is a cross section view of an example construction of the emitter shown in FIG. 3 taken along the lines A-A in FIG. 52;

FIG. 53B is a cross section view of another example construction of the emitter shown in FIG. 3 taken along the lines A-A in FIG. 52;

FIG. 54A is a cross section view of an example construction of the emitter shown in FIG. 52 operatively connected to a lateral taken along the lines A-A in FIG. 52;

FIG. 54B is a cross section view of another example construction of the emitter shown in FIG. 52 operatively connected to a lateral taken along the lines A-A in FIG. 52;

FIG. 54C is a cross section view of another example construction of the emitter shown in FIG. 52 operatively connected to a lateral taken along the lines A-A in FIG. 52;

FIG. 55A is a cross section view of an example construction of the emitter operatively connected to the lateral shown in FIG. 54A taken along the lines B-B in FIG. 54A;

FIG. 55B is a cross section view of an example construction of the emitter operatively connected to the lateral shown in FIG. 54A taken along the lines B-B in FIG. 54A;

FIG. 56 is a schematic view of a portion of a pressure reducing section of another embodiment emitter constructed in accordance with the principles of the present invention;

FIG. 57 illustrates example cross sections of geometries for floors of the emitter of FIG. 56 taken along the lines 57A-57A, 57B-57B, and 57C-57C;

FIG. 58 is a schematic view of a portion of a pressure reducing section of another embodiment emitter constructed in accordance with the principles of the present invention;

FIG. 59 is a schematic view of a portion of a pressure reducing section of another embodiment emitter constructed in accordance with the principles of the present invention;

FIG. 60 is a schematic view of a portion of a pressure reducing section of another embodiment emitter constructed in accordance with the principles of the present invention;

FIG. 61 is a schematic view of a portion of a pressure reducing section of another embodiment emitter constructed in accordance with the principles of the present invention;

FIG. 62A is a graph illustrating flow versus pressure for a prior art emitter;

FIG. 62B is a graph illustrating incremental exponent versus mid flow for the prior art emitter of FIG. 62A;

FIG. 62C is a graph illustrating flow versus pressure for an embodiment emitter;

FIG. 62D is a graph illustrating incremental exponent versus mid flow for the emitter of FIG. 62C;

FIG. 63A is a schematic view of a portion of a pressure reducing section of an embodiment prior art emitter;

FIG. 63B is a schematic view of a portion of a pressure reducing section of an embodiment prior art emitter;

FIG. 63C is a schematic view of a portion of a pressure reducing section of another embodiment emitter constructed in accordance with the principles of the present invention;

FIG. 63D is a schematic view of a portion of a pressure reducing section of another embodiment emitter constructed in accordance with the principles of the present invention;

FIG. 63E is a schematic view of a portion of a pressure reducing section of another embodiment emitter constructed in accordance with the principles of the present invention;

FIG. 63F is a chart comparing various features of the emitters shown in FIGS. 63A-63E;

FIG. 64A includes graphs illustrating incremental exponent versus mid flow for each region and for the overall emitter of the prior art emitter shown in FIG. 63A;

FIG. 64B includes graphs illustrating incremental exponent versus mid flow for each region and for the overall emitter of the example emitter shown in FIG. 63C;

FIG. 65 is a schematic view of another embodiment emitter constructed in accordance with the principles of the present invention;

FIG. 65A is a graph illustrating % of total pressure drop versus flow for a first embodiment of three regions of the emitter shown in FIG. 65;

FIG. 65B is a graph illustrating incremental exponent versus mid flow for the first embodiment shown in FIG. 65A;

FIG. 65C is a graph illustrating % of total pressure drop versus flow for a second embodiment of three regions of the emitter shown in FIG. 65;

FIG. 65D is a graph illustrating incremental exponent versus mid flow for the second embodiment shown in FIG. 65C;

FIG. 66 is a schematic view of a portion of a pressure reducing section of another embodiment emitter constructed in accordance with the principles of the present invention;

FIG. 67 is a schematic view of a portion of a pressure reducing section for contrast with Regions 1 and 2 of the pressure reducing section shown in FIG. 66;

FIG. 68 is a schematic view of Region 1 of the pressure reducing section shown in FIG. 66 illustrating flow;

FIG. 69 is a schematic view of Region 2 of the pressure reducing section shown in FIG. 66 illustrating flow;

FIG. 70 is a schematic view of a portion of a pressure reducing section of another embodiment emitter constructed in accordance with the principles of the present invention;

FIG. 71 is a schematic view of Region 1 of the pressure reducing section shown in FIG. 70 illustrating flow; and

FIG. 72 is a schematic view of Region 2 of the pressure reducing section shown in FIG. 70 illustrating flow.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of emitters are illustrated schematically in the drawings. It is understood that floors interconnect the various features and rails and that outlet apertures are part of the lateral wall. A person having ordinary skill in the art will appreciate that various emitter components have suitable thicknesses. Suitable thicknesses could range from 0.004 to 0.048 inch.

It is also to be understood that the phrases “at least one of A and B”, “at least one of A or B” and the like should be understood to mean “only A, only B, or both A and B”.

A drip irrigation emitter generally includes an inlet section, followed by at least one of a pressure reducing section and/or a pressure responsive section, followed by an outlet section. In this invention, it is preferred that the emitter includes a pressure reducing section and an optional pressure responsive section. Generally, the pressure reducing section, the optional pressure responsive section, and the outlet section include a floor and opposing rails from which features in the pressure reducing and optional pressure responsive sections extend. Preferably, this invention relates to emitters made of thermoplastics or thermosetting plastics, which are relatively rigid, meaning they do not significantly change shape or deflect in response to pressure. Emitters are positioned along the length of the lateral, and flow and pressure can vary along the length of the lateral. The present invention establishes an ability to have a relatively uniform incremental exponent, 0.5 for example, over the general full range of pressure along the length of the lateral. The present invention also enables operating at lower pressure ranges as well, by moving downward to lower flowrates, the range at which the incremental exponent is in the vicinity of 0.5. The invention accomplishes this by varying geometric features within the emitter resistance section (pressure reducing section) such that the result is a combination of varied transitional curves tending to offset elevated exponents with transitional exponents in such a manner to cancel the extremes and provide a more consistent exponent. This invention enables exponent tuning without the need for a pressure responsive section. However, this invention can be used within the pressure reducing section of a pressure responsive emitter and/or within the features of a pressure responsive section as well. Those conversant in emitter design would recognize that an emitter with a pressure responsive section would use material that may be elastomeric, or a combination of elastomeric and non-elastomeric. As stated, the primary benefit of the invention would be recognized by using multi-transitional approach to providing consistent incremental exponent versus flow for a pressure reducing section within an emitter that includes pressure responsive section.

Example emitters include pressure reducing sections having varying geometry to achieve the desired incremental exponent of approximately 0.5 (e.g., 0.45-0.55). The varying geometry can include variations along the length of the pressure reducing section and/or asymmetrical sides (the features along opposing rails).

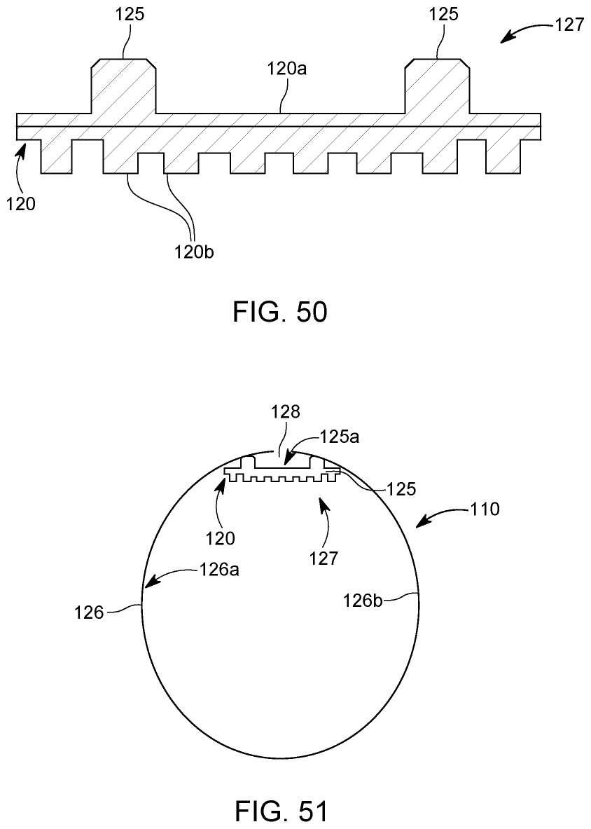

An example emitter flow path is shown in FIG. 50 and an example emitter flow path operatively connected to an irrigation lateral with a lateral flow path is shown in FIG. 51. Although FIG. 50 depicts a two layer construction, it is recognized that construction could be one, two, or more than two layer(s). FIG. 51 shows the lamination of a substrate 120 (emitter) with rails 125 on an inner wall 126a of the lateral 126, thereby forming the irrigation hose 110. The inner wall 126a forms the main water passageway through the hose 110, including the lateral flow path 126b and the emitter flow path 125a. The substrate 120 may be applied as a continuous strip member 127 laminated to the lateral 126 in any suitable manner, such as that disclosed in U.S. Pat. No. 8,469,294. The continuous strip member 127 may be rolled up and stored for later insertion into the hose 110, or the continuous strip member 127 may go right from a mold wheel to the extruder for the lateral 126. That is, the lamination of the rails 125 and substrate 120 (including top surface 120a and fins 120b) from the mold wheel is positioned inside of the die head extruding the lateral 126 thereby forming the irrigation hose 110. Suitable inlets (not shown) allow passage of water from the lateral flow path 126b into the emitter flow path 125a. Suitable outlets 128 are formed in the irrigation hose 110 proximate the outlet section of the substrate 120, by means well known in the art.

These prior art emitter designs are non-limiting examples, and it is recognized that other suitable emitter designs could be used with the present invention including continuous emitter designs, hot melt emitter designs, discrete emitter designs, and in-seam emitter designs.

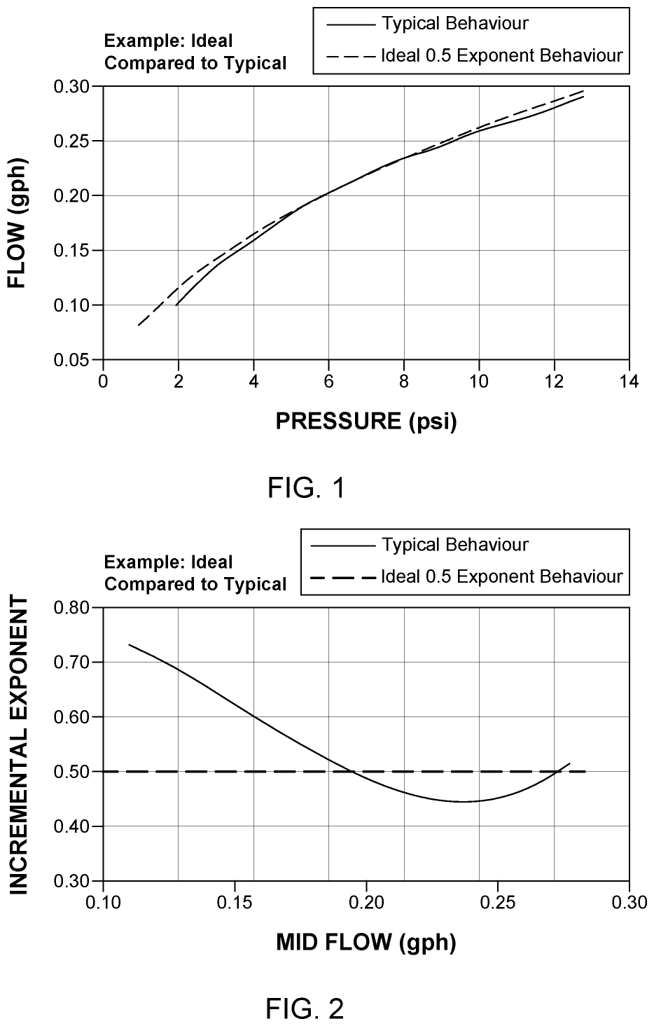

Drip irrigation lateral manufacturers commonly specify exponents to relate flow versus pressure as follows: Flow=Constant×Pressure\hat{ }(exponent). However, these exponents are overall exponents over the entire stated range of operating pressures. For example, an overall exponent is preferably within the range of 0.45 to 0.55, while ideally maintaining a steady exponent consistent over the entire operating pressure range. Said differently, an example emitter with an overall exponent of 0.48 from minimum to maximum stated operating pressure ideally would have an incremental exponent of 0.48 for each pressure increment over the entire pressure range. Examples of typical and ideal exponent behaviors are compared in FIGS. 1 and 2. FIG. 1 illustrates pressure (pounds/square inch (“psi”)) versus flow (gallons/hour (“gph”)) for typical emitter behavior and an ideal 0.5 exponent behavior, and FIG. 2 illustrates mid flow (gph) versus incremental exponent for typical emitter behavior versus an ideal 0.5 exponent behavior. To reiterate what was stated previously, the emitter is not ideal because the overall exponent is 0.5, in the context of this invention, the emitter is ideal because the incremental exponent is 0.5 consistently over the pressure range. As shown for the typical behavior example, the actual exponent varies as a function of in which portion of the pressure/flow curve it is operating. If the pressure/flow is in the lower end, the exponent in vicinity of that flow would be higher than the overall average. If the emitter is operating in the flow range where the emitter is transitioning, the exponent would be less than the overall average.

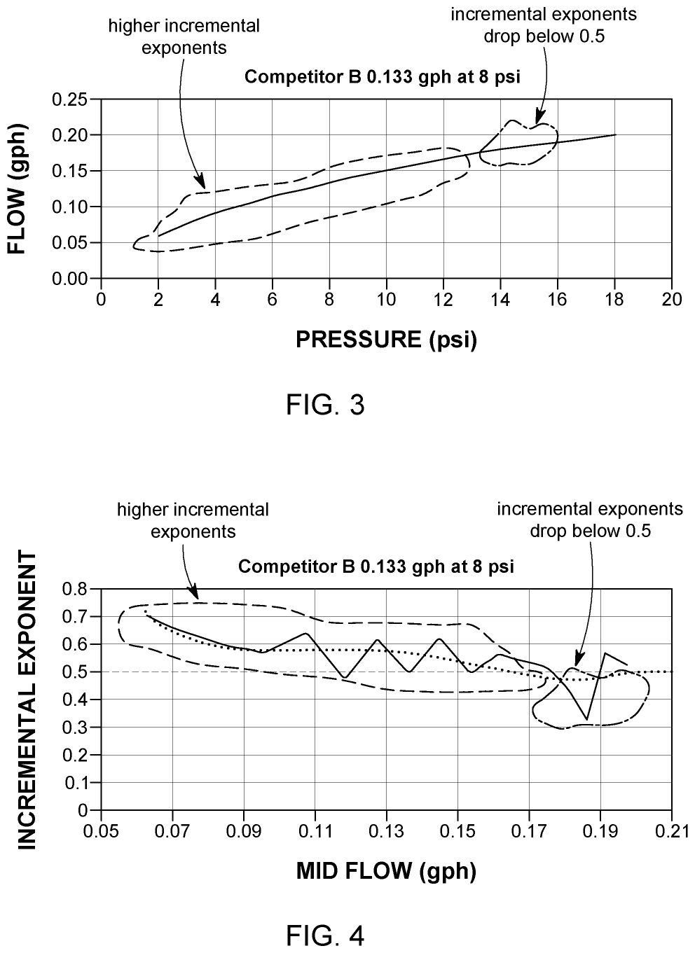

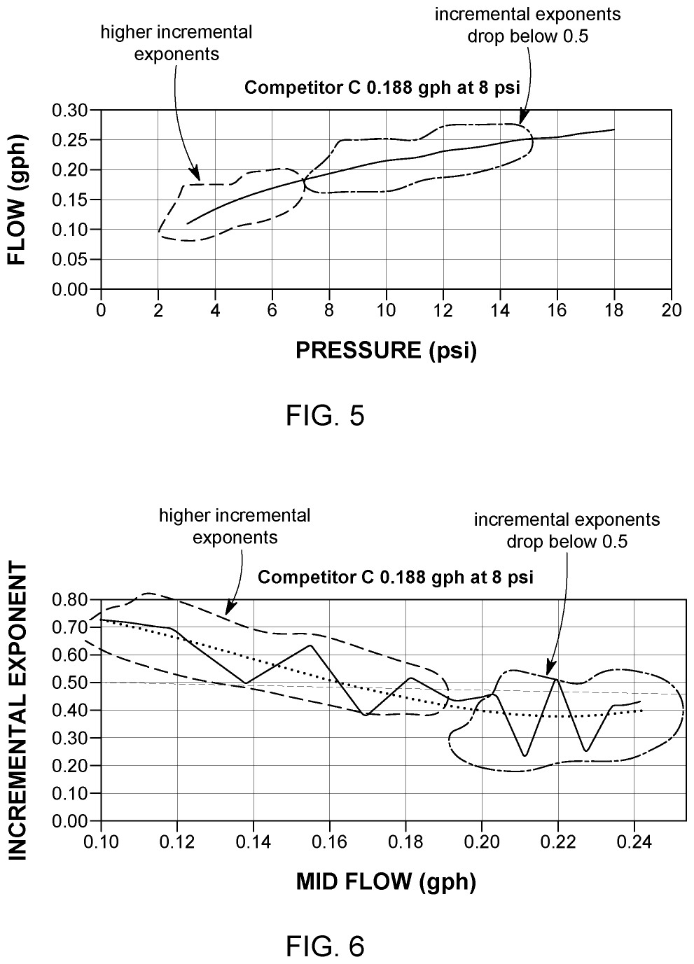

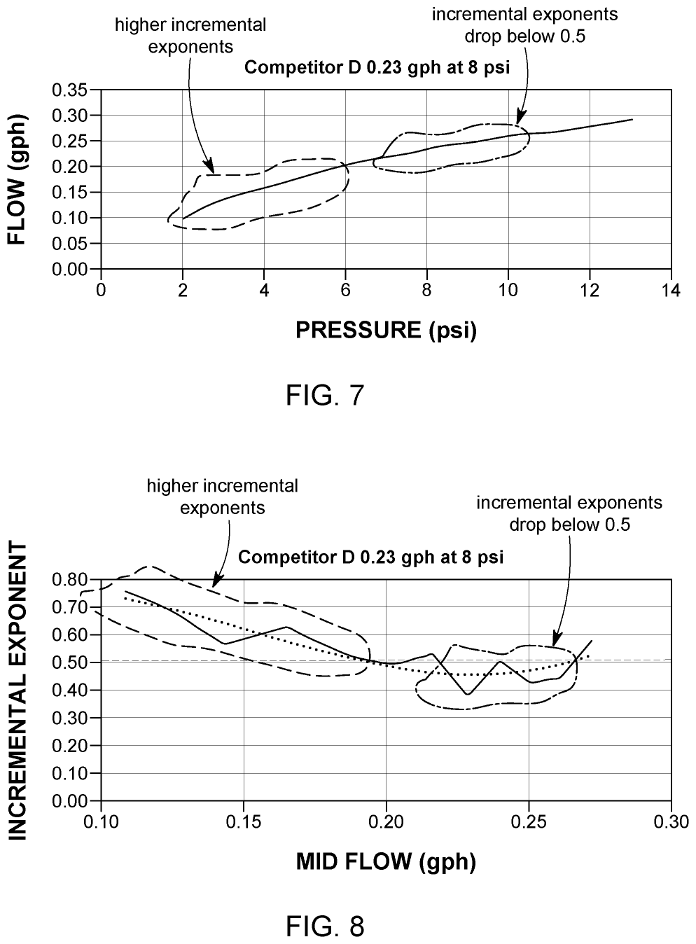

FIGS. 3-8 illustrate examples from a variety of drip irrigation manufacturers, labeled Competitors B, C, and D, which do not include pressure responsive sections, to compare pressure (psi) versus flow (gph) and mid flow (gph) versus incremental exponent. Competitor B has a flow of 0.133 gph at 8 psi, Competitor C has a flow of 0.188 gph at 8 psi, and Competitor D has a flow of 0.230 gph at 8 psi. General physics defines that at lower flow rates the incremental exponents are higher (see the circled portions on the left in FIGS. 4, 6, and 8), generally becoming smaller as flow rates increase, then during transitional flow rate ranges the incremental exponents drop below 0.5 (see the circled portions on the right in FIGS. 4, 6, and 8), then as flow rates increase further the exponents increase until settling to be 0.5 steady.

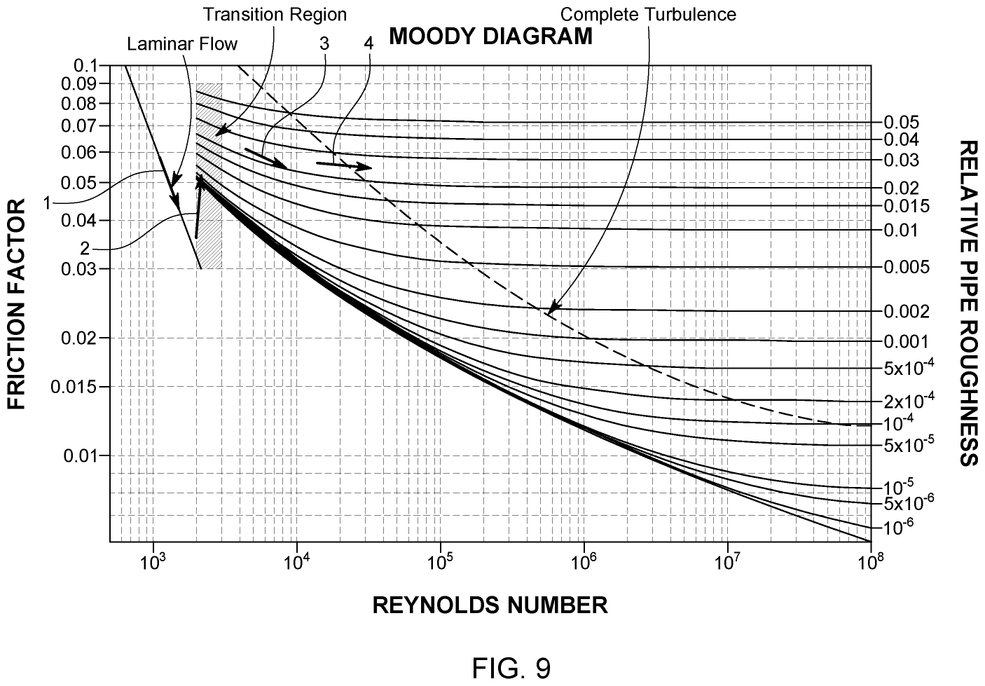

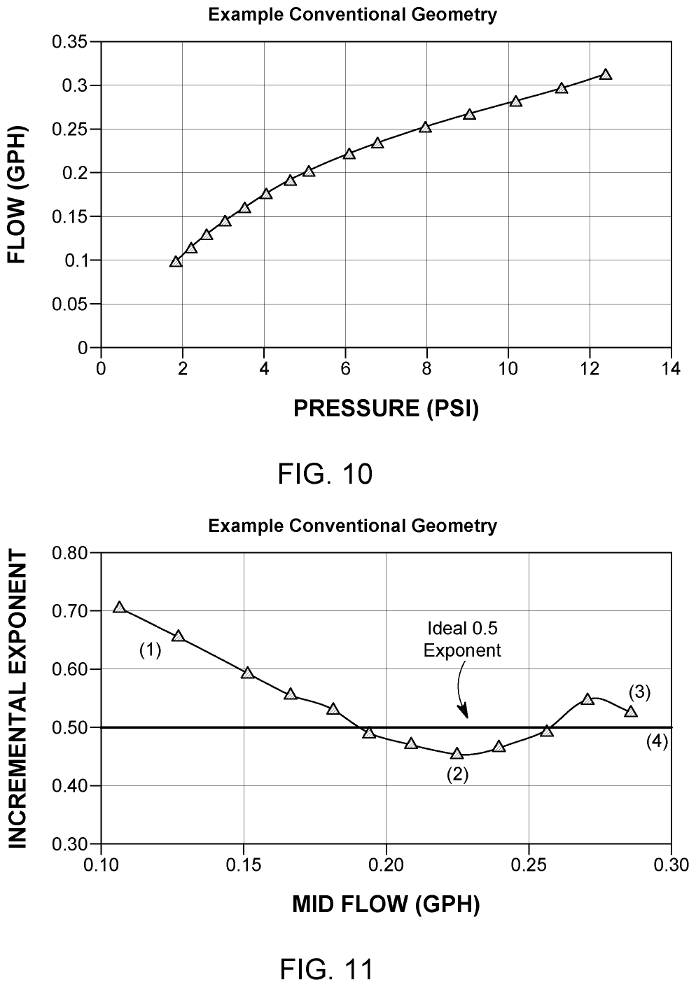

This is analogous to behavior in pipes, for example, as illustrated in the annotated Moody Diagram in FIG. 9, which illustrates a friction factor. Existing conventional emitters additionally shown in FIGS. 10 and 11 behave directly analogous to any flow which transitions from laminar to turbulent. For example, region (1) of the Moody Diagram shows the resistance to flow is decreasing with increasing flow. In an emitter, such as the example shown in FIG. 11, this region has an exponent of above 0.5. Region (2) shows the resistance to flow increases as the flow transitions toward turbulent behavior. In an emitter the exponent departs to be below 0.5 while the resistance increases as the flow transitions. Region (3) shows the resistance to flow gently decreases and in the emitter the exponent is a bit above 0.5. Region (4) shows the resistance to flow is constant with increasing flow, which is fully turbulent behavior. In an emitter, the exponent will be 0.5 steady beyond that point. An example emitter shown in FIGS. 10 and 11 did not reach fully turbulent behavior (i.e., exponent approaches steady 0.5 beyond ˜0.30 gph).

Product performance and the ability to design overall installations (e.g., farm installations) can benefit by having a more consistent exponent over the stated emitter flow rate. The current invention makes use of combining different geometric features in order to accomplish multiple transitional flow conditions. By superimposing the behaviors of multiple features, the overall exponent behavior that the product exhibits can be adjusted to minimize the overall exponent versus flow variations. As previously stated, Flow=Constant×Pressure\hat{ } (exponent). In addition, Incremental Exponent=Log (Flow2/Flow1)/Log (Press2/Press1), where 1 and 2 are end points for the given increment, and “mid flow” is the average of Flow1 and Flow2.

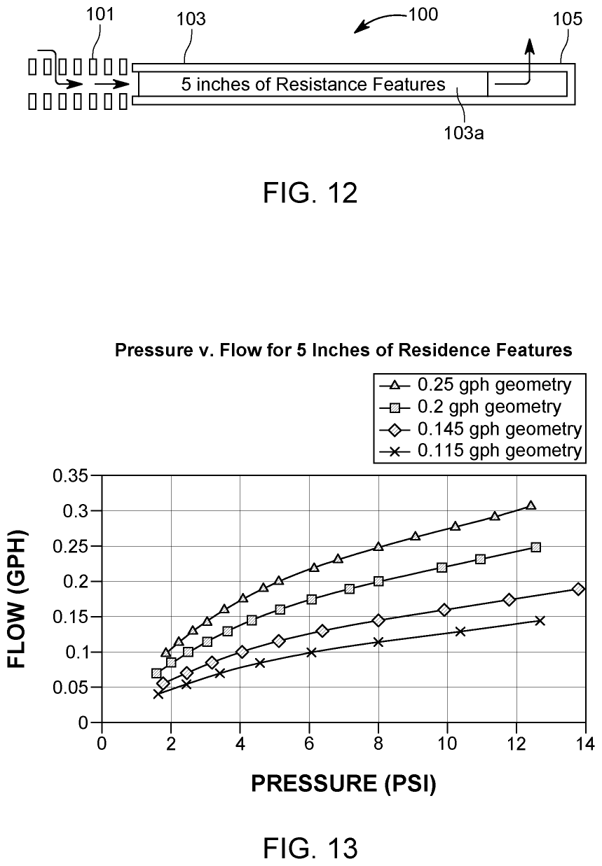

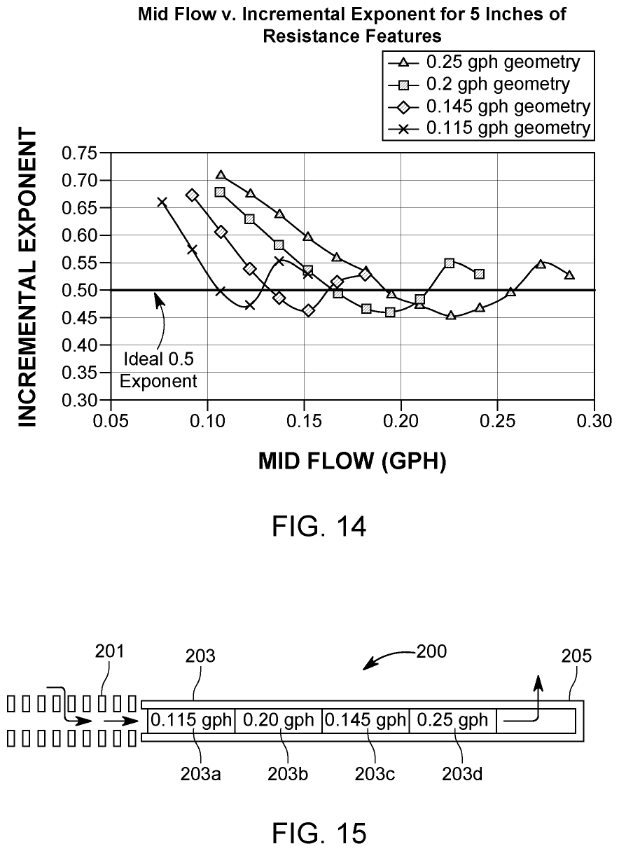

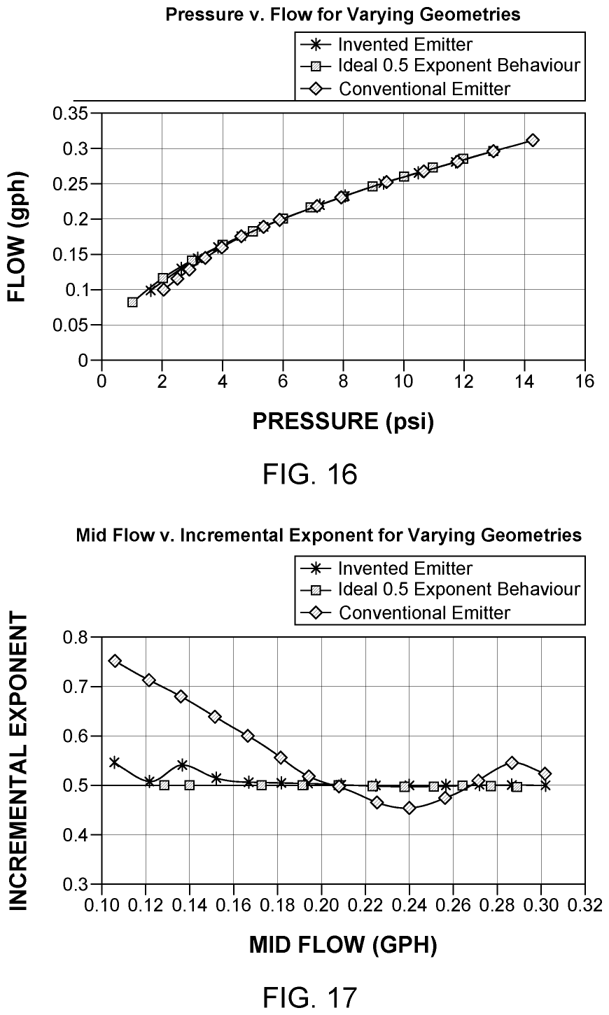

To illustrate a general concept of the invention, FIGS. 12-14 illustrate conventional emitters, with FIG. 12 illustrating a general configuration and FIGS. 13 and 14 illustrating four different geometries for pressure versus flow and mid flow versus incremental exponent; FIG. 15 illustrates an example emitter according to the principles of the present invention; and FIGS. 16 and 17 illustrate a comparison among a conventional emitter, an emitter in accordance with the principles of the present invention, and an ideal 0.5 exponent behavior for pressure versus flow and mid flow versus incremental exponent.

FIG. 12 illustrates a configuration of a conventional emitter 100 including an inlet section 101, a pressure reducing section 103, and an outlet section 105. The pressure reducing section 103 includes 5 inches of resistance features 103a. As illustrated in FIGS. 13 and 14, the resistance features 103a of four different conventional emitters have geometries resulting in flow rates of 0.115 gph, 0.145 gph, 0.200 gph, and 0.250 gph at pressures of 8 psi.

In FIG. 15, the example emitter 200 includes an inlet section 201, a pressure reducing section 203, and an outlet section 205. The pressure reducing section 203 includes 1.25 inches of 0.115 gph geometry 203a, in series with 0.50 inch of 0.20 gph geometry 203b, in series with 0.80 inch of 0.145 gph geometry 203c, in series with 0.40 inch of 0.25 gph geometry 203d, for a total combined length of features in series of 2.95 inches.

The conventional emitters 100 of FIGS. 12-14 have a single geometry. With the example emitter 200 of FIG. 15, mixing geometries with differing transition flow rates, the combined response can be adjusted. Increasing the number of differing geometries provides opportunity for improved response, as illustrated in FIGS. 16 and 17.

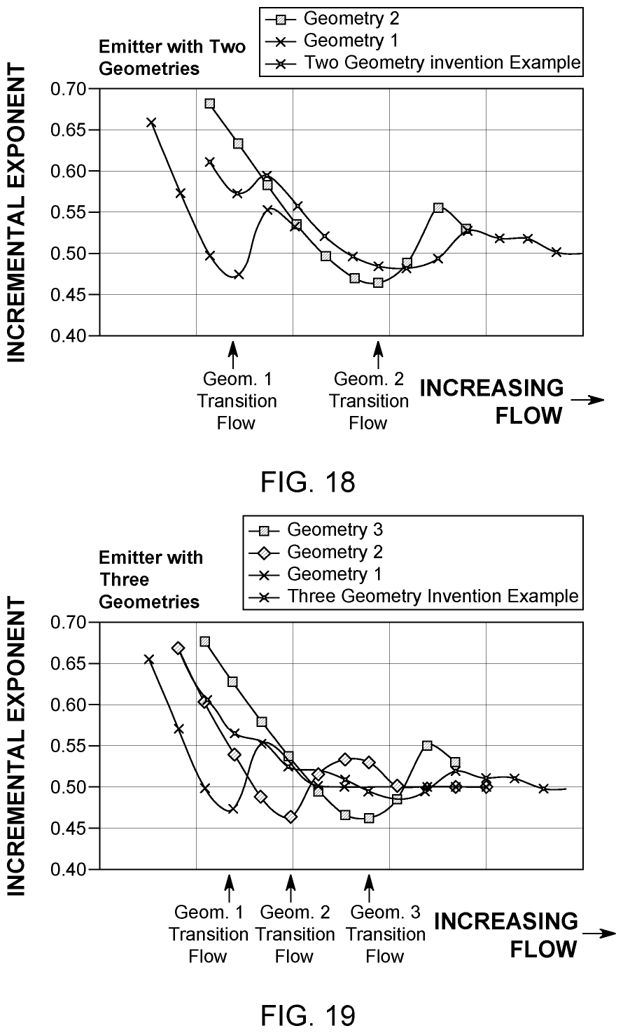

FIG. 18 illustrates an example emitter with two geometries compared to each geometry separately. In this example, feature count was set such that the pressure drops contributed by geometries 1 and 2 were roughly comparable.

FIG. 19 illustrates an example emitter with three geometries compared to each geometry separately. In this example, feature count was set such that pressure drops contributed by geometries 1, 2 and 3 were roughly comparable. In addition to adjusting the flow at which transition occurs for a given geometry, additional tuning can be accomplished by selecting comparative contributions to the overall pressure drop (i.e., if more pressure drop is created by a given geometry, then its contribution to the overall exponent curve will be higher).

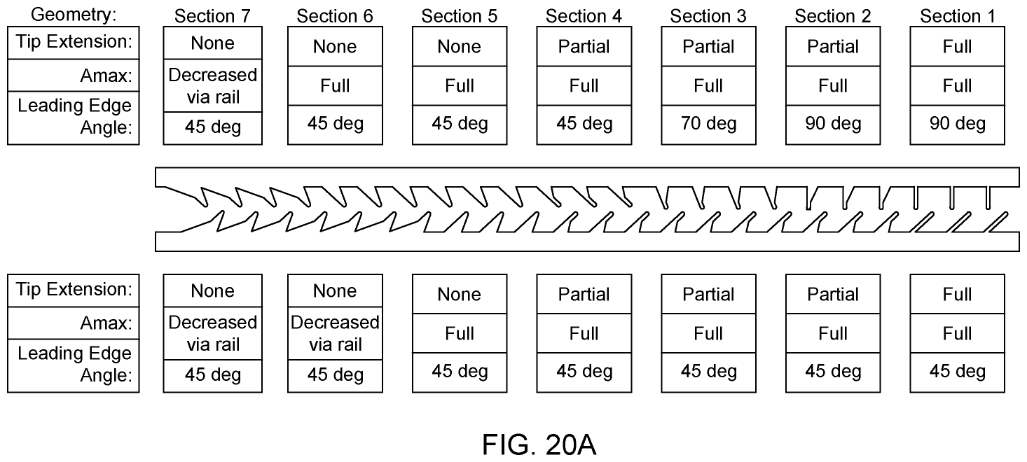

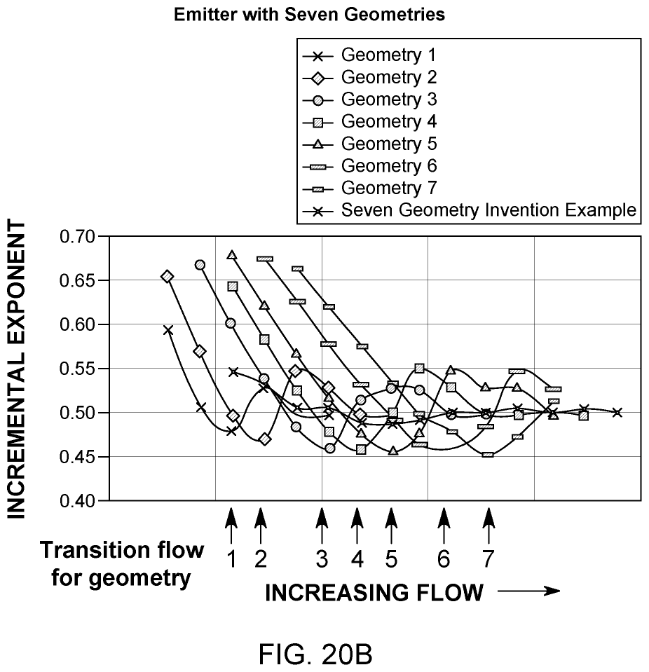

FIG. 20A is an example emitter with seven different sections of resistance features. Each section has a different incremental exponent versus flow behavior. The overall exponent versus flow behavior is defined by the combined behaviors for the seven sections. The difference in behavior between one section and the next section is adjusted by changing the geometry in one aspect, on one side only for sections 7 to 6, sections 6 to 5, sections 4 to 3, and sections 3 to 2, while changing the geometry in one aspect on both sides for sections 5 to 4 and sections 2 to 1. The geometry changes between sections 4 to 3 and sections 3 to 2 are related to one geometric element (feature angle) on one side only. From sections 5 to 4 and sections 2 to 1 changes were made relative to one geometric element (tip extension) on both sides. It is understood that any combination can be used, such as changing one geometric element along one side and/or changing two geometric elements along the other side (not shown). Alternatively, the changes could relate to both sides in conjunction such as changing the tip-to-tip distance. Although this example emitter is shown as an injection molded discrete emitter, it is recognized that a continuous strip or continuous hot melt style emitter could be used. This example emitter is compared to individual emitters, one for each geometry separately, in FIG. 20B.

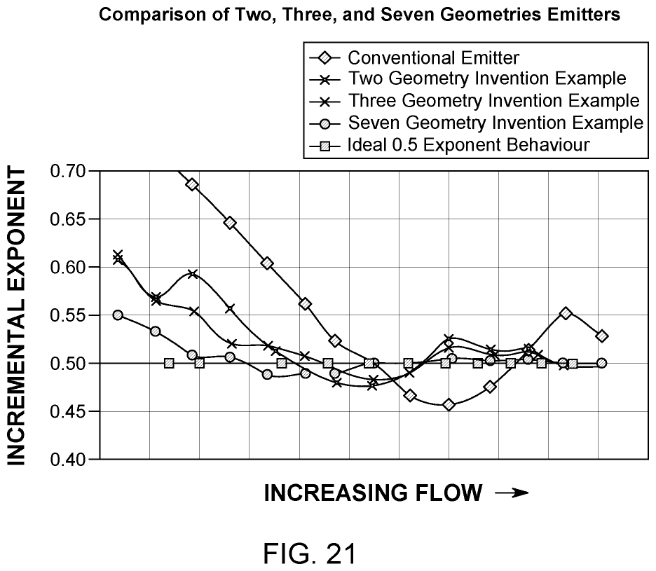

FIG. 21 is a comparison of the example emitters of FIGS. 18, 19, and 20A. The seven sections of different geometries of FIG. 20A combine to more closely follow ideal than either the two or three geometry examples. If a progression of geometries (such as 25 features in series each selected to have differing responses) is used, the overall response curve can be further flattened, for example. Any geometry style with desired individual transition flows can be used.

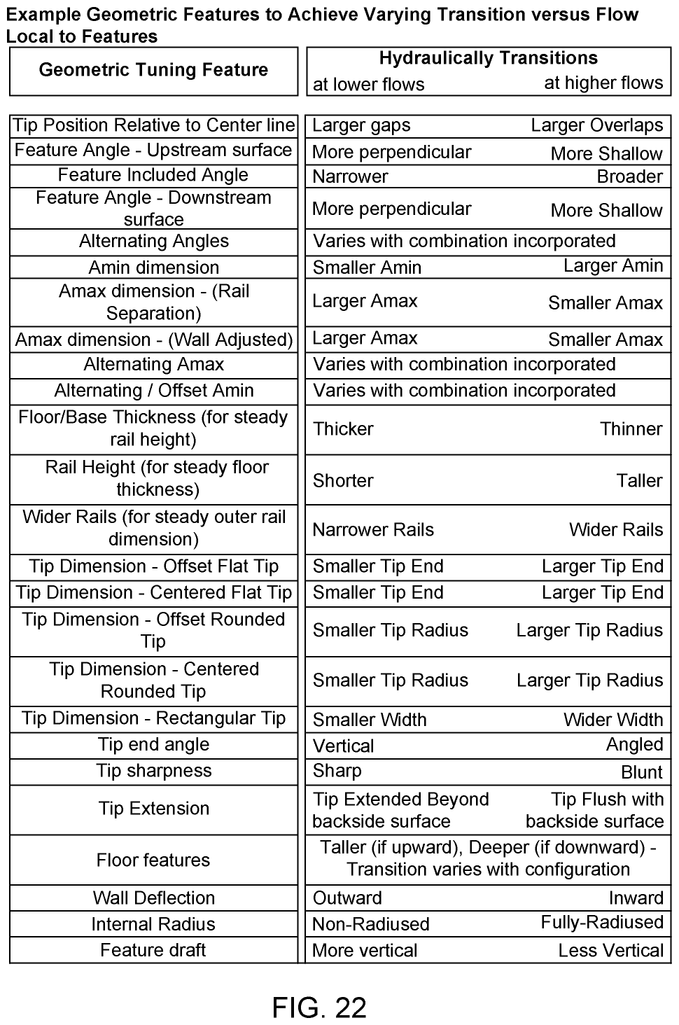

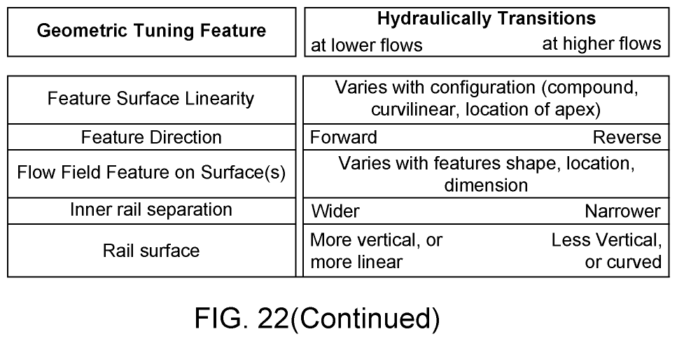

Example geometric features (geometries) that can be used to achieve varying transition versus flow local to features are shown in FIG. 22. For example, various tuning features can be utilized in a variety of fashions, including:
Series—successive increments of resistance sections differ in one or more geometric manner, the order of the features does not matter because flow will pass through each and every geometry as passes from inlet section through pressure reducing section to outlet section;
Progression—a progression of feature changes through the pressure reducing section;
Interspersed—the features can be used without having to be in series or transitioning but rather alternating or varied interspersed along the pressure reducing section;
Tuning features can be used individually or multiple styles in any combination; and
Other tuning geometries than those listed in FIG. 22, or depicted within this overall description, can be used to produce differing transitional flow behaviors in differing locations of the overall resistance section. Any suitable geometry may be used, and varying the geometry in one or more manner(s) that shifts the transition flowrate may be used to create a combined response.

As shown in FIG. 22, various geometric tuning features can be used to achieve desired hydraulic transitions (e.g., lower flows to higher flows). Positions of the feature tips relative to a center line (longitudinal axis) can have larger gaps at lower flows to larger overlaps to transition at higher flows. The angles of the features relative to the rails can have upstream surfaces more perpendicular at lower flows to more shallow to transition at higher flows. The angles of the features relative to the rails can have downstream surfaces more perpendicular at lower flows to more shallow to transition at higher flows. Feature included angles (non-linear features) can be narrower (smaller included angle) at lower flows to broader (larger included angle) to transition at higher flows. The angles of the features can alternate. Amin dimensions (dimensions between opposing adjacent features) can be smaller at lower flows to larger to transition at higher flows. The Amin can alternate or be offset. Amax dimensions (dimensions between features and opposing rail portions) can be larger at lower flows and smaller to transition at higher flows. The Amax dimension relative to the opposing rail can be adjusted by changing either the distance between rails of consistent width, or by changing the width of the rails (i.e. the distance between the innermost surface of the rails can be changed by displacing the rails, or by changing the thickness/width of the rails). The Amax can alternate. The floor or base thickness can vary by being thicker at lower flows to thinner to transition at higher flows. The rail height can vary by being shorter at lower flows to taller to transition at higher flows. The rail widths can be narrower at lower flows and wider to transition at higher flows. The feature tips can vary by having an offset flat tip with a smaller tip end at lower flows to a larger tip end to transition at higher flows, a centered flat tip with a smaller tip end at lower flows to a larger tip end at higher flows, an offset rounded tip with a smaller tip end at lower flows to a larger tip end to transition at higher flows, a centered rounded tip with a smaller tip end at lower flows to a larger tip end to transition at higher flows, or a rectangular tip with a smaller width at lower flows to a wider width to transition at higher flows. The tip end angles can be vertical (parallel to the longitudinal axis) at lower flows to angled to transition at higher flows. The tip extensions can extend beyond the features' backside/downstream surfaces at lower flows to being flush with the features' backside/downstream surfaces to transition at higher flows. The floor features can be taller to deeper relative to adjacent floor section depending upon the configuration. The walls can be deflected outward at lower flows to inward to transition at higher flows. The features can be non-radiused at lower flows to radiused to transition at higher flows. The features can be configured and arranged to create less to more draft by being more vertical at lower flows to less vertical to transition at higher flows. The features can be linear or can include non-linear surfaces such as including compound curvilinear surfaces. The feature directions can be forward (pointing upstream) at lower flows to reverse (pointing downstream) to transition at higher flows. The features can include flow field features on surfaces. The inner surfaces of the opposing rails can have varying separation such as wider separation at lower flows to narrower separation to transition at higher flows. The rails can have inner surfaces that are more vertical or more linear at lower flows to less vertical or more non-linear to transition at higher flows.

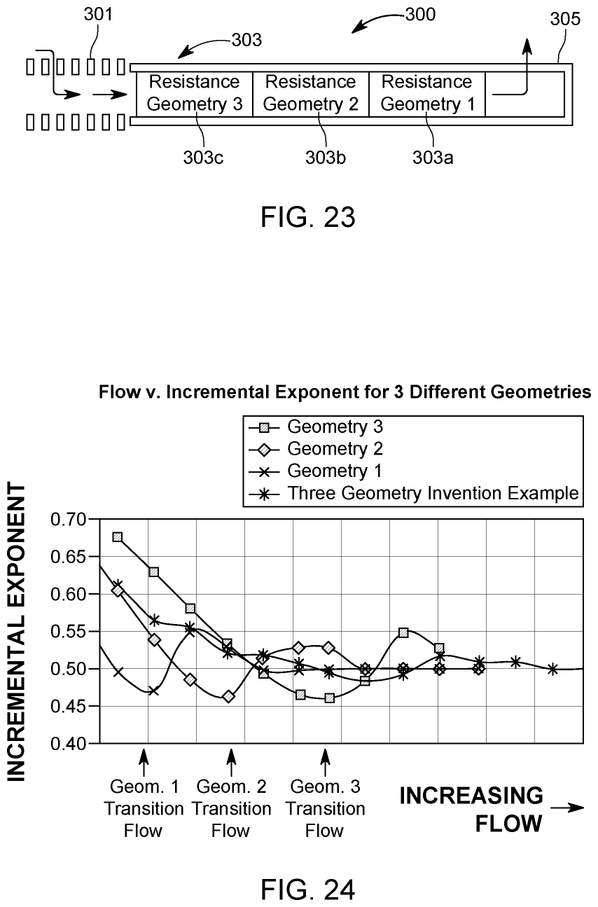

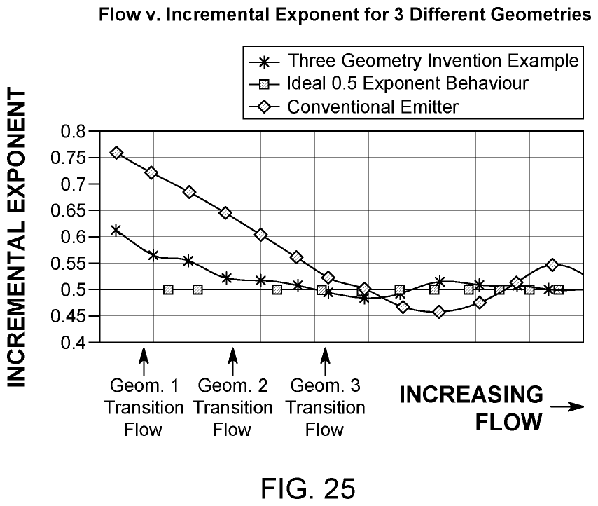

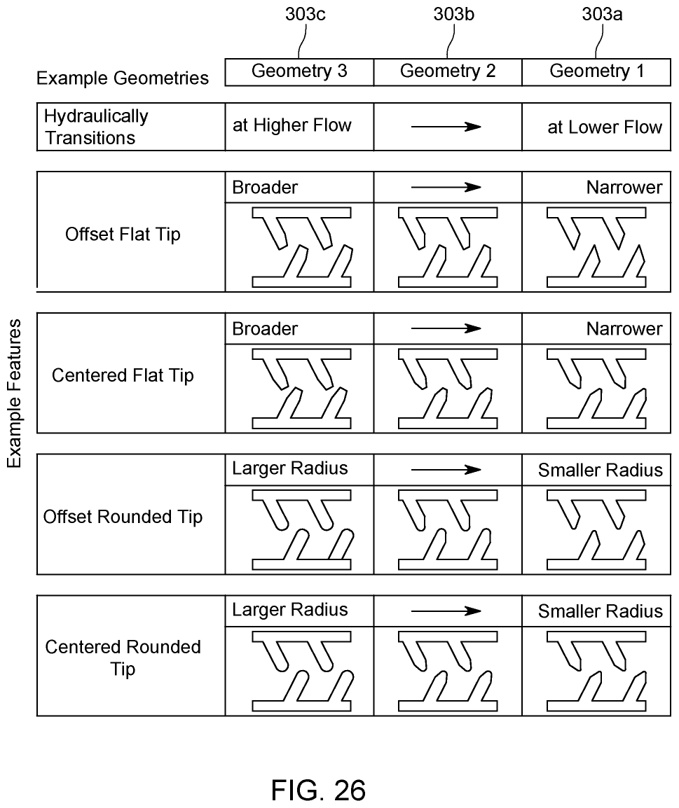

Another example is illustrated in FIGS. 23-26. An example emitter 300 includes an inlet section 301, a pressure reducing section 303, and an outlet section 305. The pressure reducing section 303 includes geometry 303c, followed by geometry 303b, followed by geometry 303a. Example resistance feature geometries are shown in FIG. 26. The example features are described as being “centered”, meaning the center of the feature's tip is centered between the upstream and downstream faces of the feature, and “offset”, meaning the center of the feature's tip is not centered between the upstream and downstream faces of the feature. As shown in FIGS. 24-26, if the resistance feature geometries utilized are offset flat tip shaped, a grouping of geometry 303c, in series with a grouping of geometry 303b, in series with a grouping of geometry 303a result in an overall incremental exponent versus flow relationship which is closer to ideal 0.5 exponent as a result of superimposing the incremental exponents versus flow for each of the three groupings of geometries. The sequence can be in any order. For example, geometries 303c and 303a could be swapped. This example is simplified by combining directly in series. It is recognized that changes in tip geometry can be made progressively as well, for example (i.e., rather than using three distinct groups each of which group having consistent tip geometry, the changes in tip geometry can be made progressively different with each feature throughout the overall emitter. Any combination of series and or progression could be used to tune the overall flattening of incremental exponent versus mid flow).

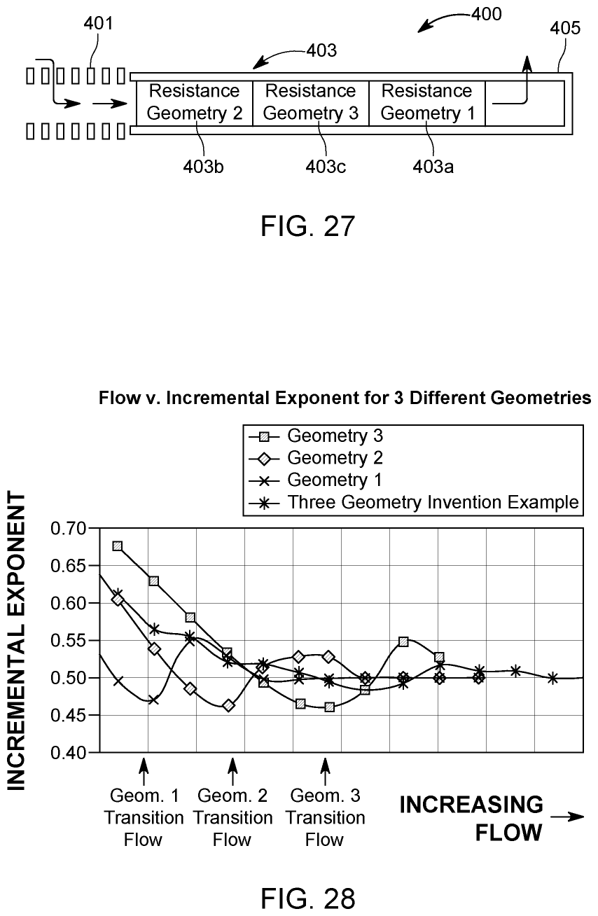

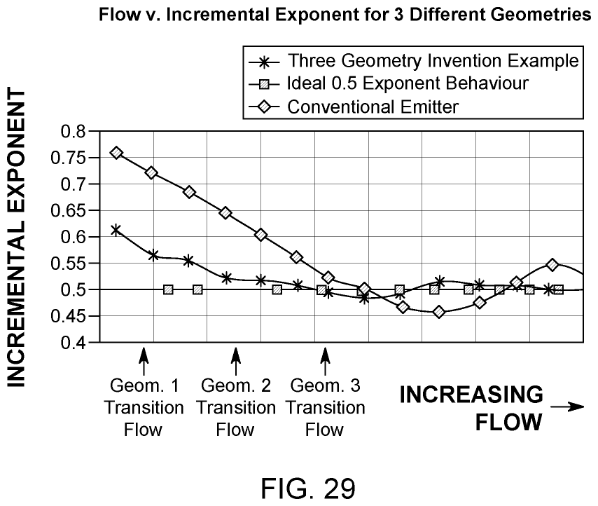

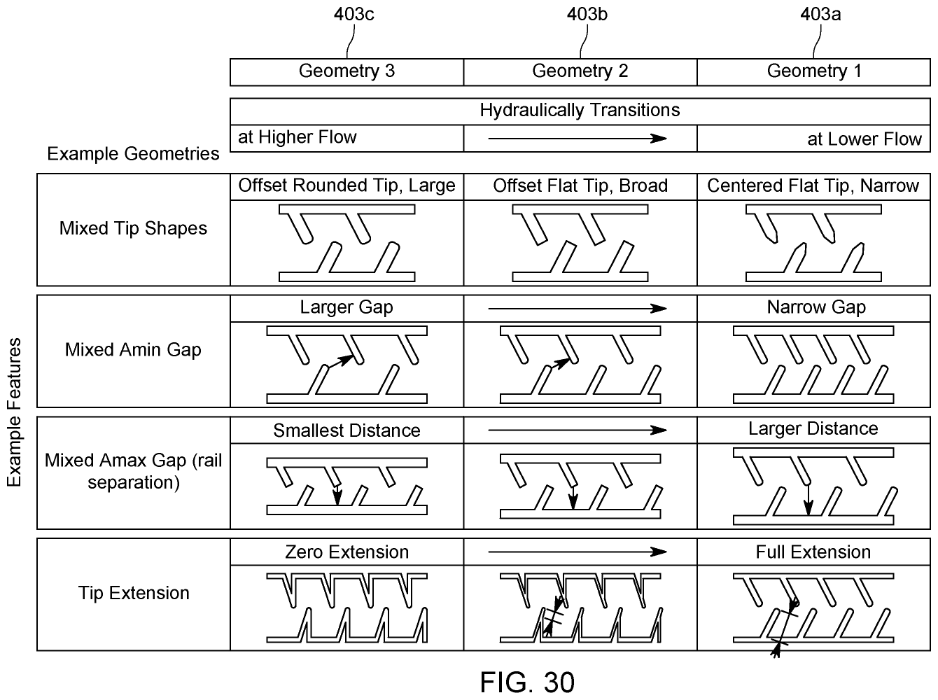

Another example is illustrated in FIGS. 27-30. An example emitter 400 includes an inlet section 401, a pressure reducing section 403, and an outlet section 405. The pressure reducing section 403 includes geometry 403b, followed by geometry 403c, followed by geometry 403a. Example resistance feature geometries are shown in FIG. 30. The example features are described as being “mixed tip shapes”, meaning the features can have offset rounded large tips, offset flat broad tips, or centered flat narrow tips; “mixed Amin gap”, meaning larger to narrower gaps between opposing adjacent features; “mixed Amax gap”, meaning smaller to larger distances between a feature and an opposing rail portion; and “tip extension”, meaning a distance a narrowed segment of the feature including the tip extends beyond a generally wider segment of the feature generally adjacent to the rail. Any combination of geometries can be used, with the objective for a given combination of geometries to be such that the combination of their individual relationships between incremental exponent versus flow, results in an overall combined emitter with desired overall incremental exponent versus flow relationship. FIG. 27 differs from FIG. 23 to illustrate that the order does not matter, the resistances are in series and their contributions to the overall performance does not depend upon the sequence.

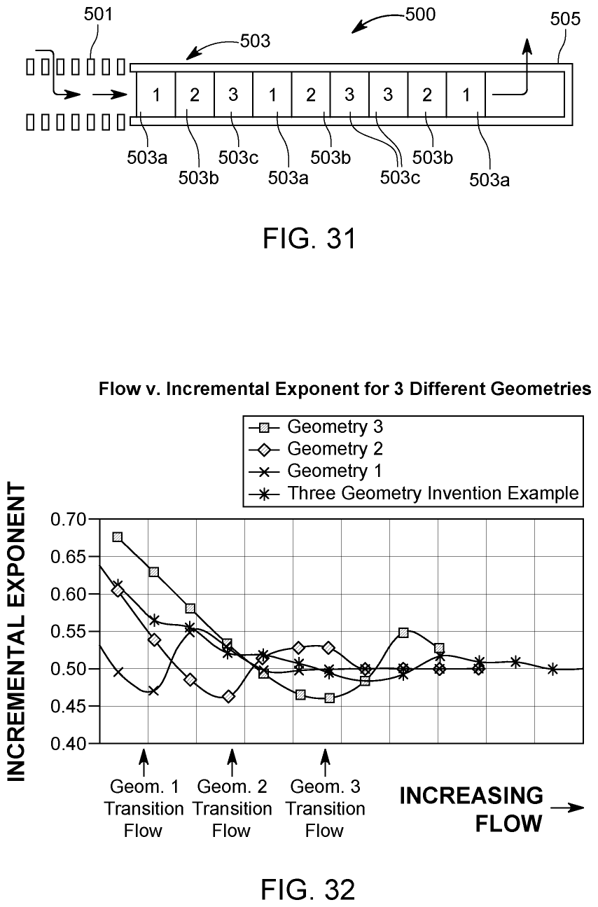

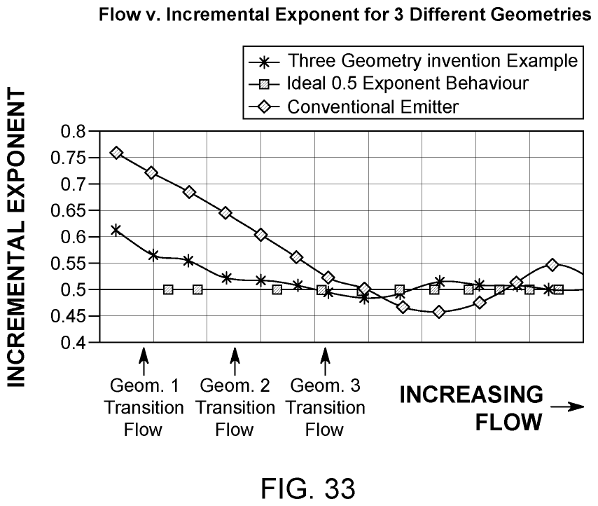

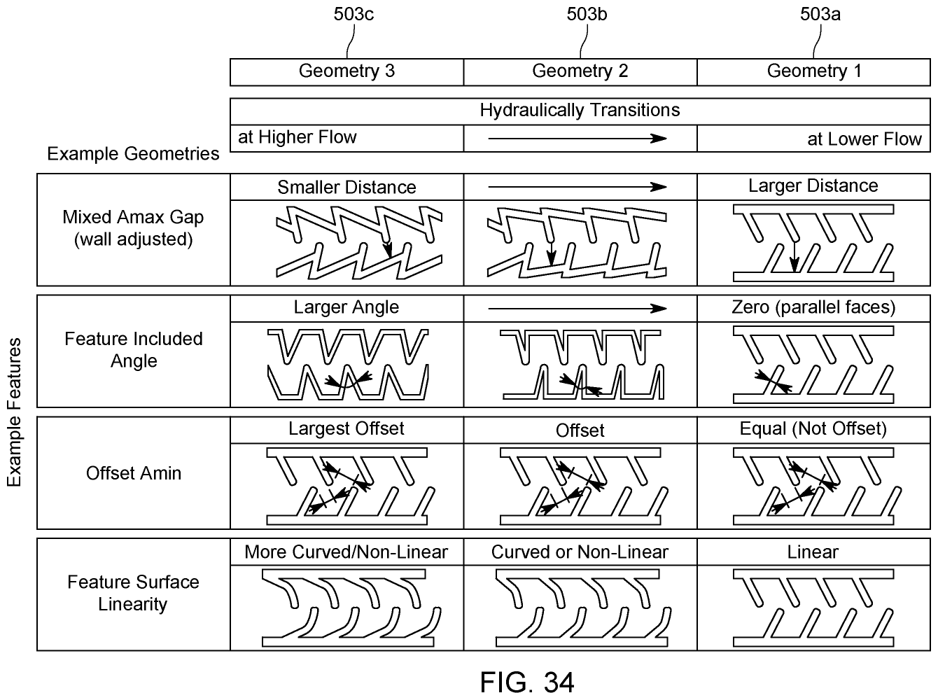

Another example is illustrated in FIGS. 31-34. An example emitter 500 includes an inlet section 501, a pressure reducing section 503, and an outlet section 505. The pressure reducing section 503 includes geometry 503a, followed by geometry 503b, followed by geometry 503c, followed by geometry 503a, followed by geometry 503b, followed by geometry 503c, followed by geometry 503c, followed by geometry 503b, followed by geometry 503a. Example resistance feature geometries are shown in FIG. 34. The example features are described as being “mixed Amax gap”, meaning smaller to larger distances between a feature and an opposing rail portion that is angled; “feature included angle”, meaning larger to zero (parallel) angles created by opposing sides or faces of the features; “offset Amin”, meaning larger to equal (not offset) distances or spaces between adjacent tips; and “feature surface linearity”, meaning curved or non-linear to linear surfaces. Any combination of geometries can be used, with the objective for a given combination of geometries to be such that the combination of their individual relationships between incremental exponent versus flow, result in an overall combined emitter with desired overall incremental exponent versus flow relationship. FIG. 31 differs from FIGS. 23 and 27 to illustrate that the order does not matter, the resistances are in series, and their contribution to the overall performance does not depend upon the sequence or having to be grouped together.

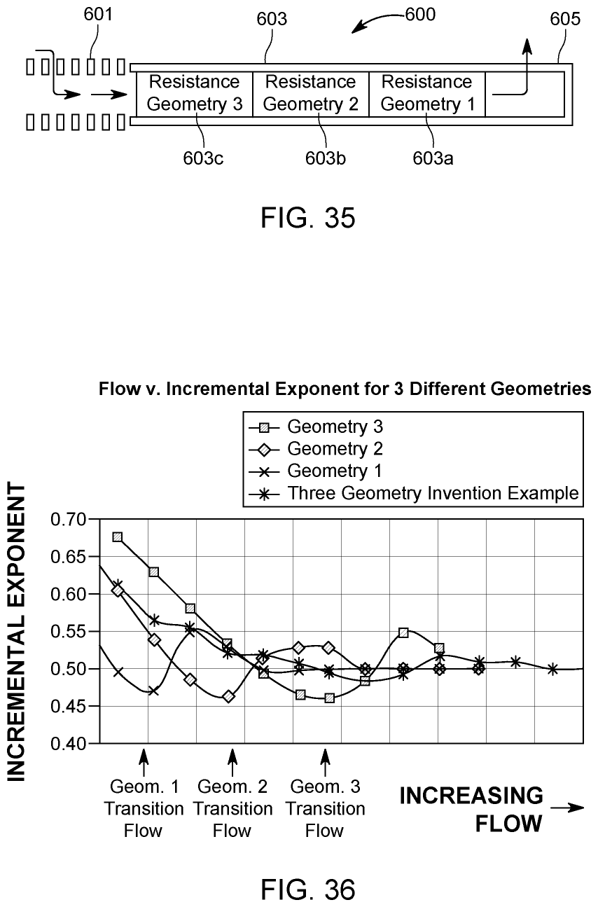

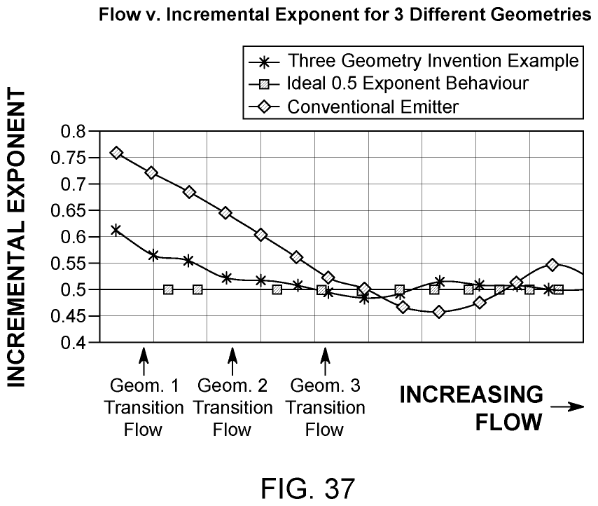

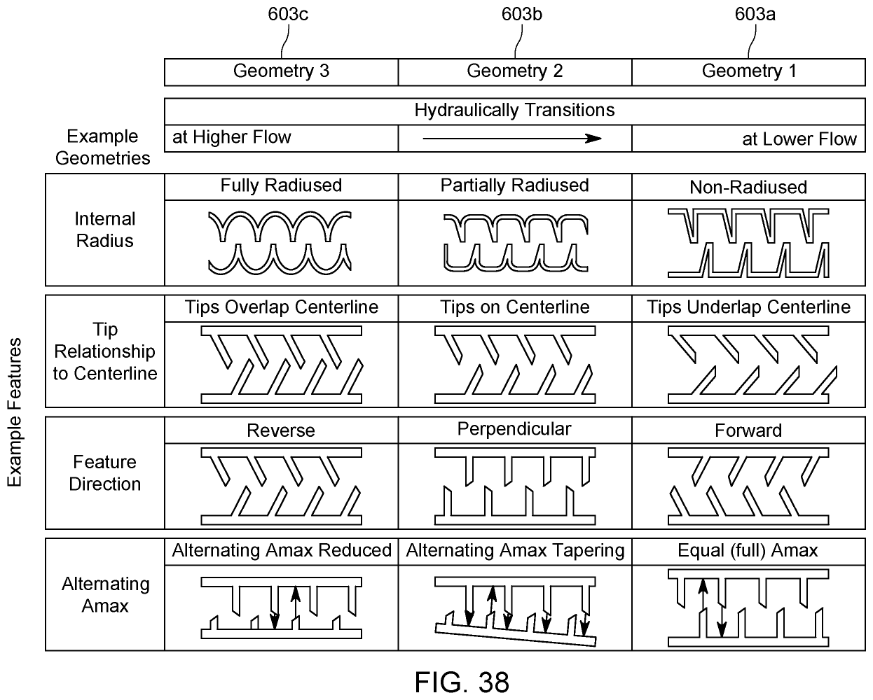

Another example is illustrated in FIGS. 35-38. An example emitter 600 includes an inlet section 601, a pressure reducing section 603, and an outlet section 605. The pressure reducing section 603 includes geometry 603c, followed by geometry 603b, followed by geometry 603a. Example resistance feature geometries are shown in FIG. 38. The example features are described as being “internal radius”, meaning fully radiused to non-radiused (angled) relationship between intersection of base of feature and rail from which it extends; “tip relationship to centerline”, meaning the feature tips overlap (extend over) the centerline to underlap (stop short of) the centerline; “feature direction”, meaning the features extend in a reverse direction (toward the outlet section) to a forward direction (toward the inlet section); and “alternating Amax”, meaning successive distances between feature tip and opposing rail vary to taper to equal. Any combination of geometries can be used, with the objective for a given combination of geometries to be such that the combination of their individual relationships between incremental exponent versus flow, result in an overall combined emitter with desired overall incremental exponent versus flow relationship. For the first row of features in FIG. 38, the rail can form at least part of the resistance feature. The resistance feature can be solid or include voids are gaps, and this is true for any depiction in this description.

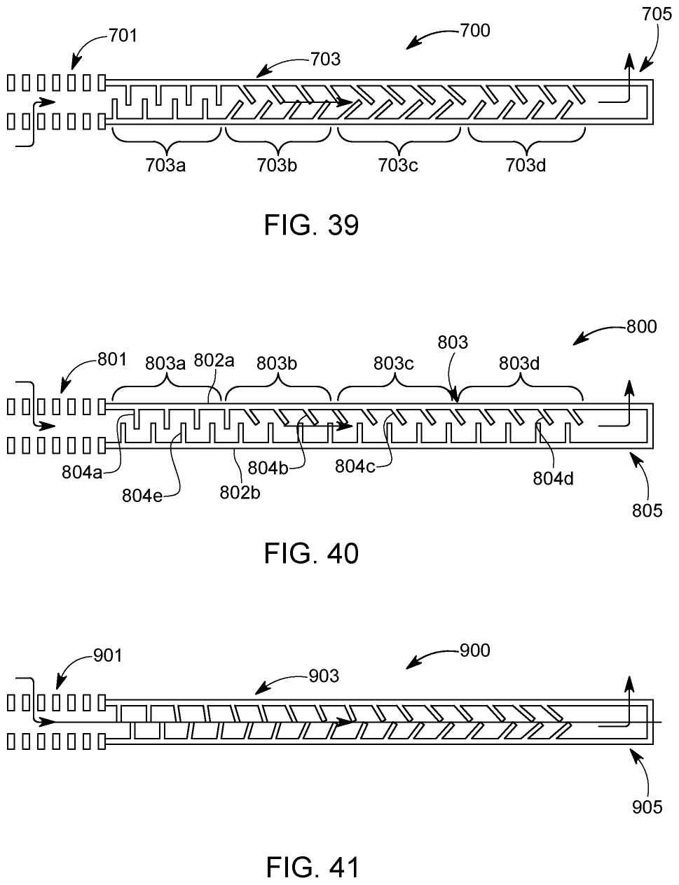

FIG. 39 illustrates an example emitter 700 including an inlet section 701, a pressure reducing section 703, and an outlet section 705. The pressure reducing section 703 includes features with varying angles relative to the rails from which they extend. Features in section 703a are approximately perpendicular to their rails, features in section 703b are angled approximately 60 degrees toward the outlet section 705, features in section 703c are angled approximately 45 degrees toward the outlet section 705, and features in section 703d are angled approximately 60 degrees toward the outlet section 705. In this example, a single transition tuning feature (feature angle) is adjusted to differ for features generally within four groupings (703a thru 703d) in series along the pressure reducing section 703 wherein the incremental exponent behavior for the overall emitter is more consistent as a result of using invention of combining incremental exponent behaviors for differing geometries.

FIG. 40 illustrates an example emitter 800 including an inlet section 801, a pressure reducing section 803, and an outlet section 805. The pressure reducing section 803 includes features extending from a first rail 802a with varying angles relative to the first rail 802a and features extending from an opposing, second rail 802b. Features extending from the first rail 802a include features 804a in section 803a approximately perpendicular to the first rail 802a, features 804b in section 803b angled approximately 60 degrees toward the outlet section 805, features 804c in section 803c angled approximately 45 degrees toward the outlet section 805, and features 804d in section 803d angled approximately 60 degrees toward the outlet section 805. Features 804e extend approximately perpendicular from the opposing, second rail 802b along the length of the pressure reducing section 803. In this example, a single transition tuning feature is used with varying angles along one rail in series and is used with right angles along the opposing rail. It is recognized that the various features can be individual features, one or more series of features, progressions of features, or other combinations. The features can also include alternating angles.

FIG. 41 illustrates an example emitter 900 including an inlet section 901, a pressure reducing section 903, and an outlet section 905. The pressure reducing section 903 includes features extending from opposing rails as a progression from perpendicular to more angled (e.g., 90 degrees progressing toward 45 degrees) toward the outlet section 905. The progression creates a combination of geometries, each of which transitions at a different flow rate. Feature angles and quantities can be selected to establish both overall flowrate and to create incremental exponents tailored as desired.

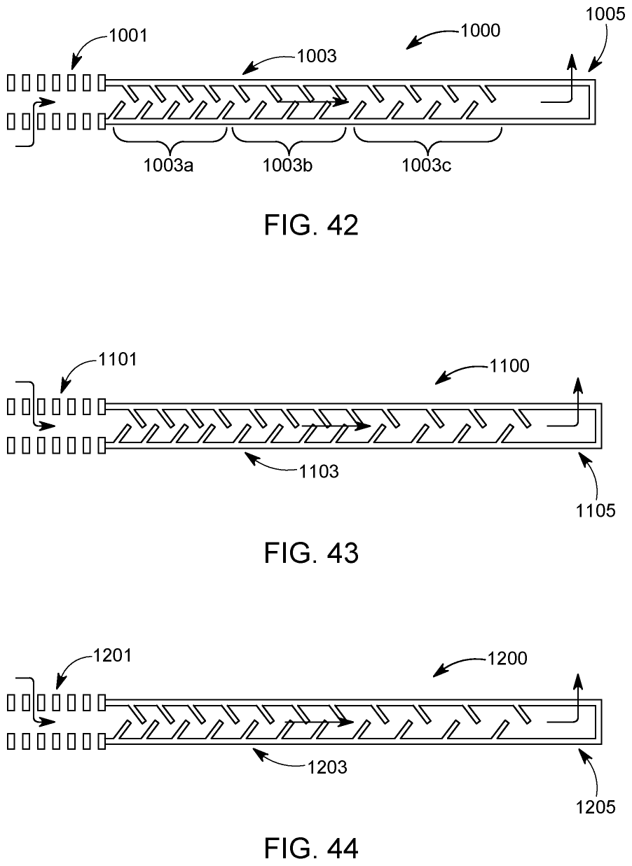

FIG. 42 illustrates an example emitter 1000 including an inlet section 1001, a pressure reducing section 1003, and an outlet section 1005. The pressure reducing section 1003 includes features extending from opposing rails with varying “Amin”, smaller to larger distances or spaces between opposing, adjacent tips to transition flow from lower to higher flow. Features in section 1003a have opposing, adjacent tips relatively closer together; features in section 1003b have opposing, adjacent tips further apart than in section 1003a; and features in section 1003c have opposing, adjacent tips further apart than in section 1003b.

FIG. 43 illustrates an example emitter 1100 including an inlet section 1101, a pressure reducing section 1103, and an outlet section 1105. The pressure reducing section 1103 includes features extending from opposing rails with varying “Amin”, smaller to larger distances or spaces between opposing, adjacent tips to transition flow from lower to higher flow. In this example, there is an interspersed alternating pattern such that there is one consistent Amin every other occurrence, interspersed with varying larger Amin occurrences. Generally, features further downstream transition at higher flows due to generally wider Amin distances.

FIG. 44 illustrates an example emitter 1200 including an inlet section 1201, a pressure reducing section 1203, and an outlet section 1205. The pressure reducing section 1203 includes features extending from opposing rails with varying “Amin”, smaller to larger distances or spaces between opposing, adjacent tips to transition flow from lower to higher flow. In this example, the features have a progression from smaller to larger distances, the Amin generally is becoming greater further downstream, which leads to transitioning happening at higher flows generally for locations further downstream. The quantities of features and Amin combinations are selected to establish both overall flowrate and to create incremental exponents tailored as desired.

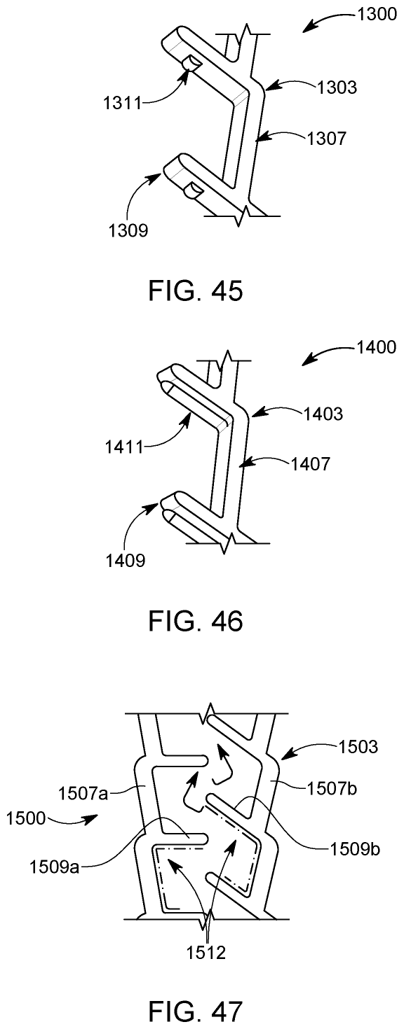

FIGS. 45 and 46 illustrate optional flow field features, which are components added to velocity vectors where flows impact face(s) of feature(s). Such flow field features can be local, partial length, full length, radiused, full height (not shown), angled (not shown), compound angle (not shown), or compound radius (not shown). Such flow field features can be used on one or more features and/or rails. FIG. 45 shows a portion of an emitter 1300 pressure reducing section 1303 having a rail 1307 from which a feature 1309 extends, and the feature 1309 includes a flow field feature 1311. FIG. 46 shows a portion of an emitter 1400 pressure reducing section 1403 having a rail 1407 from which a feature extends 1409, and the feature 1409 includes a flow field feature 1411.

FIG. 47 illustrates possible locations for such flow field features on portion of an example emitter 1500. In a pressure reducing section 1503, features 1509a and 1509b extend from opposing rails 1507a and 1507b, and dashed lines 1512 indicate possible locations for flow field features. Any portion (some or all) of the feature and/or the rail along the dashed lines 1512 can include a flow field feature. Such flow field features can be used with any resistance feature geometries, not just those illustrated in FIGS. 45-47. Not only can the flow field features affect flow rate but they can assist in avoiding clogging from debris settling in the emitter. These flow field features can aid in adjusting the flow at which a given segment of geometry transitions to turbulent behavior and can also induce debris motion by disrupting the direct action of velocity vector into surfaces.

FIG. 47 also illustrates an example configuration for the pressure reducing section 1503, which optionally can include flow field feature(s). In this example, opposing sides of the pressure reducing section 1503 are different. For example, the features 1509a are generally perpendicular to the longitudinal axis of the emitter while the features 1509b are angled toward the outlet section downstream.

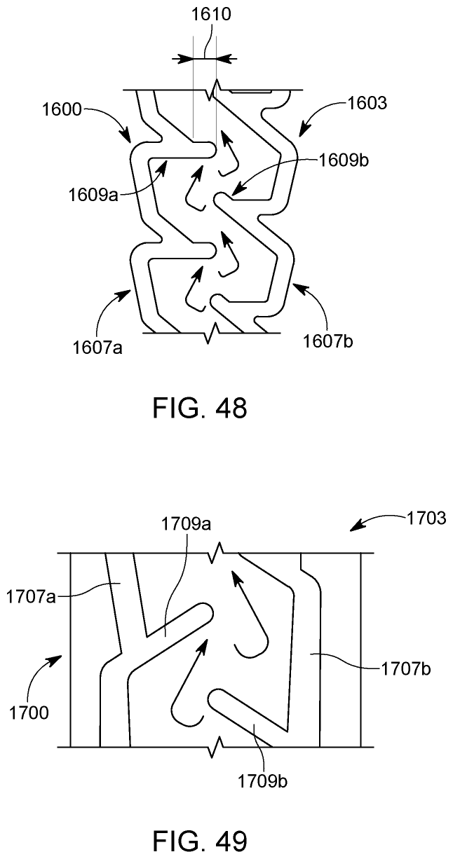

Another example configuration is illustrated in FIG. 48. A portion of an emitter 1600 includes a pressure reducing section 1603 including opposing rails 1607a and 1607b from which features 1609a and 1609b extend. In this example, opposing sides of the pressure reducing section 1603 are different. For example, the upstream and downstream faces have different lengths and angles relative to the longitudinal axis of the emitter. FIG. 48 additionally illustrates example geometry with partial tip extension 1610, formed by the very tip of features 1609a and 1609b extending beyond the backside (downstream side) of the feature.

Another example configuration is illustrated in FIG. 49. A portion of an emitter 1700 includes a pressure reducing section 1703 including opposing rails 1707a and 1707b from which features 1709a and 1709b extend. In this example, opposing sides are generally offset mirror images of each other. FIG. 49 further illustrates geometry in which the tip is fully extended, wherein the narrowed feature width of the tip extends fully along the feature the rail 1707a and 1707b. Utilizing tip extensions of varying extension is another means by which the overall emitter incremental exponent versus flow can be tuned. It would be clear to an emitter designer that any number of tip extension dimensions could be used between partially extended as depicted in FIG. 48 and fully extended as depicted in FIG. 49. Additionally, tip extension could be reduced from partially extended as depicted in FIG. 48 to zero extension as depicted as 403c in bottom row of FIG. 30.

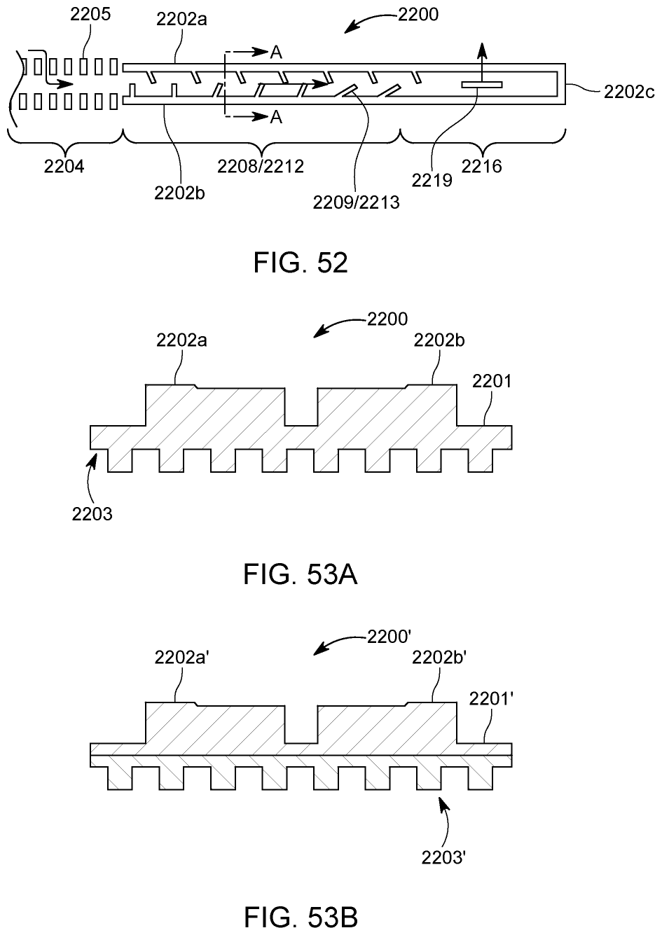

In another embodiment, illustrated in FIGS. 52, 53A, and 54A, an emitter 2200 includes an inlet section 2204, a pressure reducing section 2208 and/or a pressure responsive section 2212, and an outlet section 2216. A floor 2201 interconnects rails 2202a and 2202b, an end portion 2202c interconnecting distal ends of the rails 2202a and 2202b, and various features; and at least the rails 2202a and 2202b and the end portion 2202c are configured and arranged to connect to the inner wall 2228 of the lateral 2227 to form an irrigation lateral 2226. Optional fins 2203 can extend downward from the floor 2201 to help filter/direct any debris in the irrigation water flowing through the later flow path 2229. The inlet section 2204 includes inlet features 2205 configured and arranged to allow irrigation water to enter the inlet section 2204 while filtering at least some of the debris from entering the inlet section 2204. The pressure reducing section 2208 and/or the pressure responsive section 2212 include(s) resistance features 2209 and/or tuning features 2213, respectively, to dissipate the differential pressure existing between the inlet and outlet sections. The outlet section 2216 is in fluid communication with an outlet aperture 2219 of the lateral 2227.

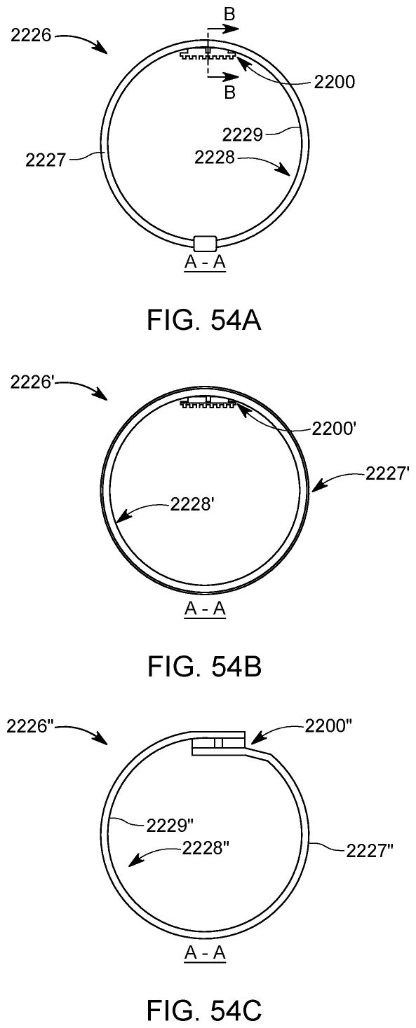

FIGS. 53A and 53B are cross sections of example emitters 2200 and 2200′ taken along the lines A-A in FIG. 52 and FIGS. 54A, 54B, and 54C are cross sections of example irrigation laterals 2226, 2226′, and 2226″ taken along the lines A-A in FIG. 52. In FIG. 53A, the emitter 2200 is illustrated as a single layer construction, which can include one or more materials. In FIG. 53B, the emitter 2200′ is illustrated as a two layer construction, and each layer can include one or more materials. In emitter 2200′, the floor 2201′ and the rails 2202a′ and 2202b′ are a first layer and the fins 2203′ are a second layer. It is recognized that one or more layers, each layer comprising one or more materials, can be used.

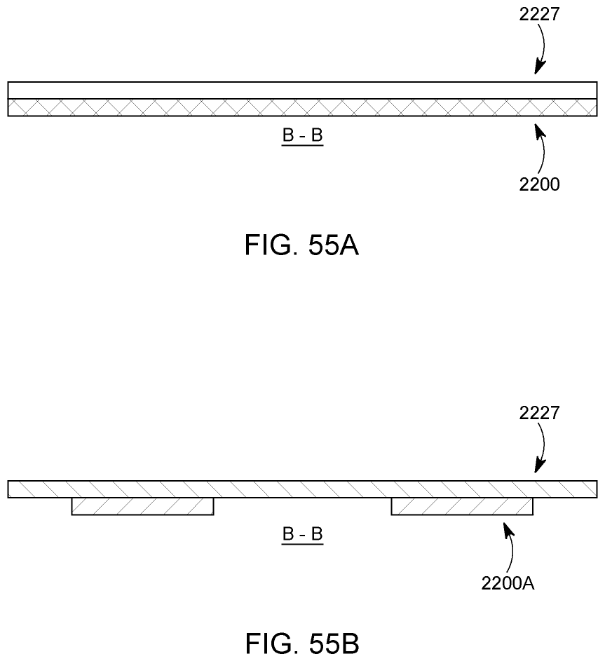

These embodiments illustrate that different types of laterals can also be used with the present invention. For example, in FIG. 54A, a seamed wall lateral 2227 is used. The emitter, for example emitter 2200, is operatively connected to an inner wall 2228 of the lateral 2227. The inlet section 2204 of the emitter 2200 is in fluid communication with the lateral flow path 2229. Another example lateral is shown in FIG. 54B. A seamless wall lateral 2226′ is shown, and the emitter, for example emitter 2200′, is operatively connected to an inner wall 2228′ of the lateral 2227′. Another example lateral is shown in FIG. 54C. An overlapping wall lateral 2226″ is shown, and the emitter, for example emitter 2200″, is operatively connected between overlapping layers of the lateral. In this example, one side of the emitter 2200″ includes inlet features that are in fluid communication with the lateral flow path 2229″. As shown in FIGS. 55A and 55B, which are cross sections taken along the lines B-B in FIG. 54A as alternate examples, the emitters can be continuous strip emitters, such as emitter 2200 in FIG. 55A, or discrete emitters, such as emitter 2200A in FIG. 55B.

These embodiments illustrate that the emitter can include a single layer construction, a double layer construction, or a multiple layer construction. Each layer can comprise one or more material(s) including non-elastomeric materials, elastomeric materials, or a combination thereof. The emitter can be a discrete emitter, a continuous strip emitter (a plurality of interconnected emitters), or an intermittent strip emitter. Similarly, the laterals can include one or more layer(s) of one or more material(s) including non-elastomeric materials, elastomeric materials, or a combination thereof. The emitters can be used with any suitable lateral such as an overlapping lateral, a seamless lateral, and a seamed wall lateral. The emitters can be operatively connected to the laterals in any suitable matter.

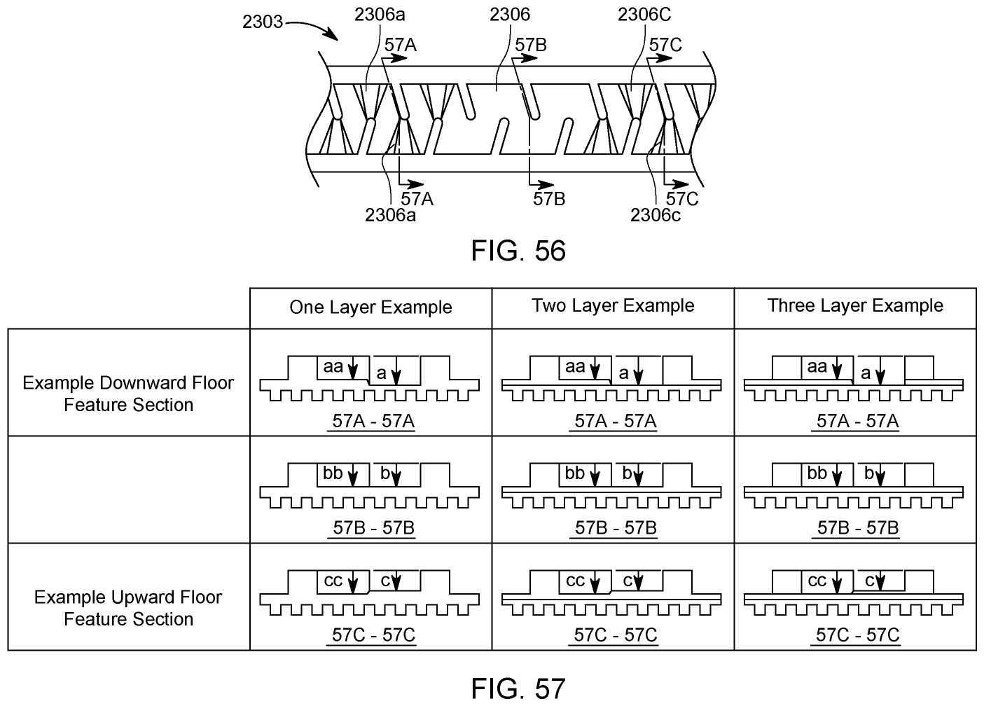

An example portion of a pressure reducing section 2303 of another embodiment emitter is illustrated in FIG. 56. In this example, downward floor features 2306a or upward floor features 2306c can be formed in the emitter floor 2306 anywhere along the flow path. Possible configurations of one, two, and three layer constructions are illustrated in FIG. 57, which illustrates alternate embodiment cross sections taken along the lines 57A-57A, 57B-57B, and 57C-57C in FIG. 56. Utilizing varying floor features allows for shifting of the flow at which the given section transitions hydraulically, not necessarily maximizing or minimizing pressure drop. For emitters including two or more layers, more than one layer can be useful for improved feature depth or height control for high production speed molding. Using multi-layer construction can enable inclusion of a high strength material in one layer and allows for a lower strength but better filling material in other layer(s). Layers do not need to be literal layers that are uni-elevation because molds laying down successive layers can be designed to be additive in different thicknesses across the web. As shown in FIG. 57, a>b>c and aa=bb=cc=b, however, other variants can exist wherein aa, bb, and cc are not the same. The downward and upward features are shown being parallel to the plane of the flow path floor, however, any number of variations can exist with regard to sloping, contouring, or non-planar shapes. An objective is to establish differing flow rates at which feature geometry for a given section transitions. Combining these differing transition flow rate geometries provides a desired composite incremental exponent versus flow rate behavior.

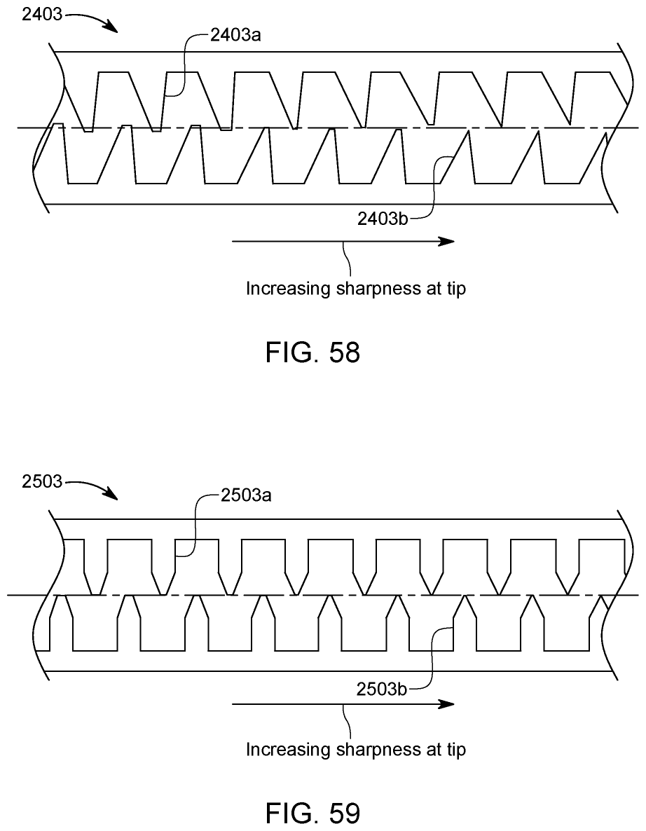

Additional example portions of pressure reducing sections are illustrated in FIGS. 58-61. In these examples, various combinations of tip sharpness and tip clearances as features are illustrated. Such features shift the flow rate at which geometry in a given section hydraulically transitions. From a mold making perspective, it can be useful to use an electrical discharge machining (EDM) to mold the features to achieve sharper feature tips. From a high speed molding perspective, filling sharper tips may require the material forming the feature tip to be capable of high speed flowing into the sharp tip cavity in the mold. This filling can be facilitated by using lower density, higher melt index material in order to flow and better conform to the sharp tip shape in the mold. However, characteristically, lower density, higher melt index materials are also in lower strength. This can contribute to processing challenges in the form of stretching and need for more sophisticated tension control. Although not necessary in order to use the concepts illustrated, the use of multi-layer, multi-material flow path construction can assist. For example, a higher density, lower melt index, higher strength formulation can be used on one or more layers to maintain overall flow path tensile strength while also using a lower density, higher melt index, lower strength material for a layer filling the feature tip.

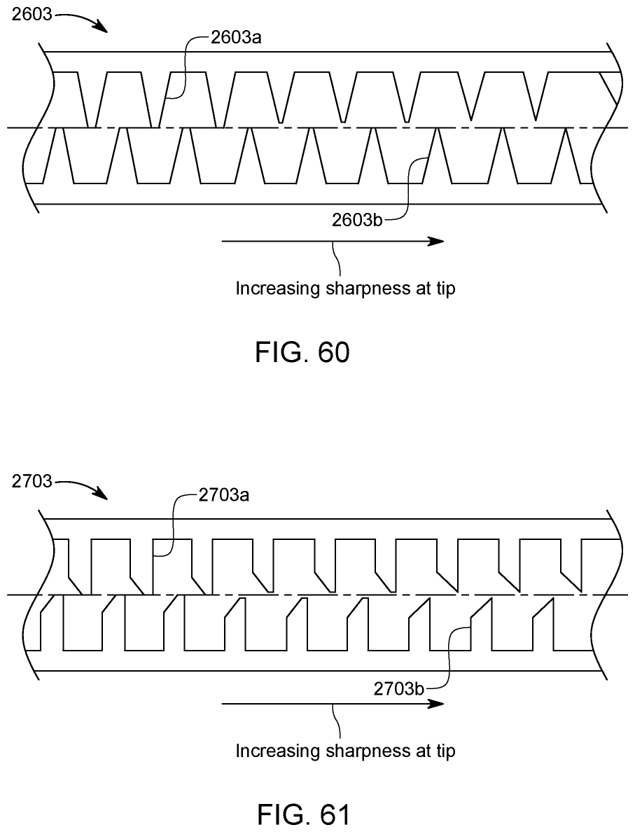

As shown in FIG. 58, the pressure reducing section 2403 includes tips such as tip 2403a that are less sharp with tips getting progressively sharper to sharp tips such as tip 2403b. This example also illustrates tip clearance ranging from over centerline, proximate tip 2403a, to gapping, proximate tip 2403b, that change progressively and symmetrically. As shown in FIG. 59, the pressure reducing section 2503 includes another configuration of tips such as tip 2503a that are less sharp with tips getting progressively sharper to sharp tips such as tip 2503b. This example also illustrates tip clearance that is consistent on the centerline. As shown in FIG. 60, the pressure reducing section 2603 includes another configuration of tips such as tip 2603a that are less sharp with tips getting progressively sharper to sharp tips such as tip 2603b. This example also illustrates tip clearance ranging from on centerline, proximate tip 2603a, to gapping from centerline, proximate tips opposing tip 2603b, changing in groups, non-symmetrically. As shown in FIG. 61, the pressure reducing section 2703 includes another configuration of tips such as tip 2703a that are less sharp with tips getting progressively sharper to sharp tips such as tip 2703b. This example also illustrates tip clearance ranging from on centerline, proximate tip 2703a, to gapping, proximate 2703b, changing in groups, symmetrically. Although each of FIGS. 58, 59, 60, and 61 generally illustrate two geometric tuning features (variations of tip sharpness, and variations of tip position relative to centerline) it would be clear to those in the art that any number of tuning features could be utilized in conjunction such that the transition behavior of differing portions of pressure reducing section can be combined to accomplish a desired overall exponent performance.

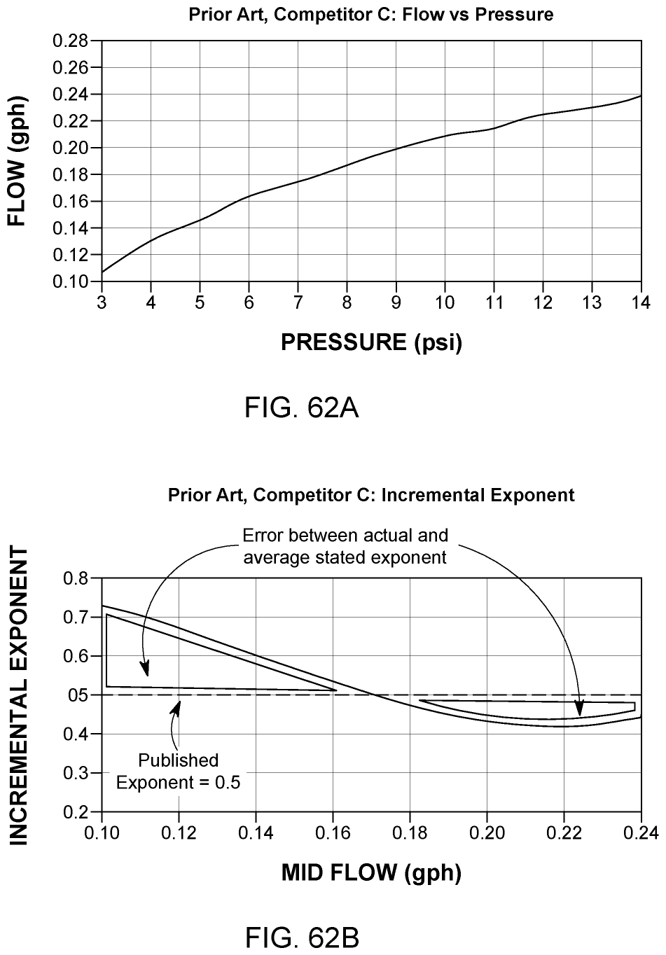

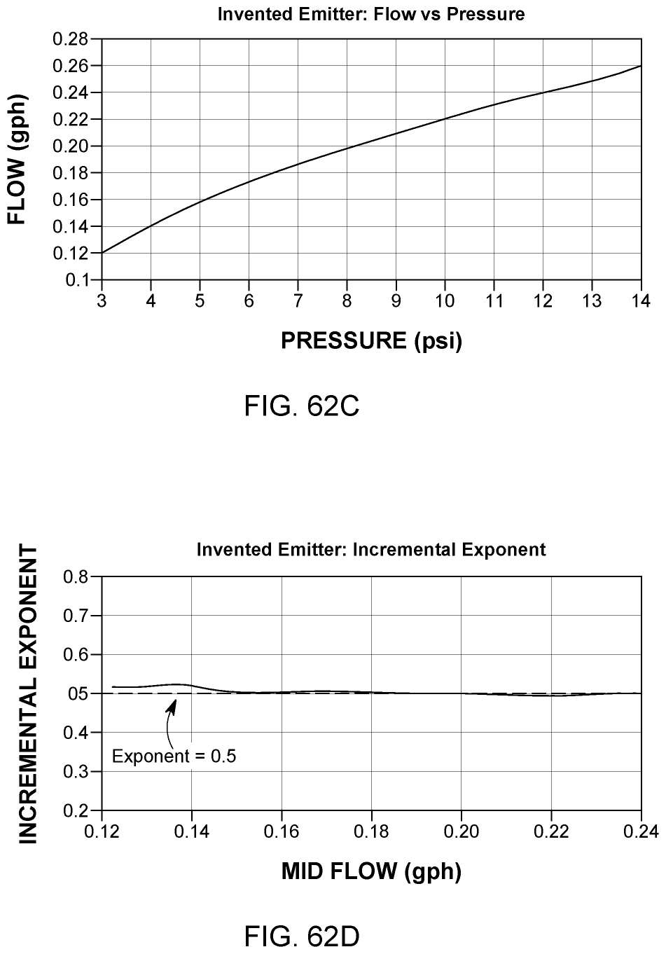

FIGS. 62A and 62C are graphs illustrating flow versus pressure and FIGS. 62B and 62D are graphs illustrating incremental exponents for a prior art emitter (Competitor C) and an example emitter of the present invention. The prior art emitter, shown in FIGS. 62A and 62B, is published to have an exponent of 0.5. Although this may be correct for an overall average exponent, the incremental exponent for the emitter ranges from approximately 0.7 to 0.4 (FIG. 62B illustrating a mid-flow rate curve) depending upon the flow rate an emitter is experiencing driven by pressure within a lateral local to the emitter. The shaded areas illustrate error between the stated exponent of 0.5 and the actual exponent (approximately 0.7 to 0.4). The difference between the published exponent and the actual exponent for a given condition represents inaccuracy for a system designer when performing performance analysis. An example emitter of the present invention, shown in FIGS. 62C and 62D, shows a flattened exponent versus a mid-flow rate curve. The flattened exponent is achieved with selected geometries that transition at different flow rates thereby evening out the actual exponent. In other words, the geometries are selected to shift transitional behavior to partially offset each other thereby resulting in an overall consistent exponent.

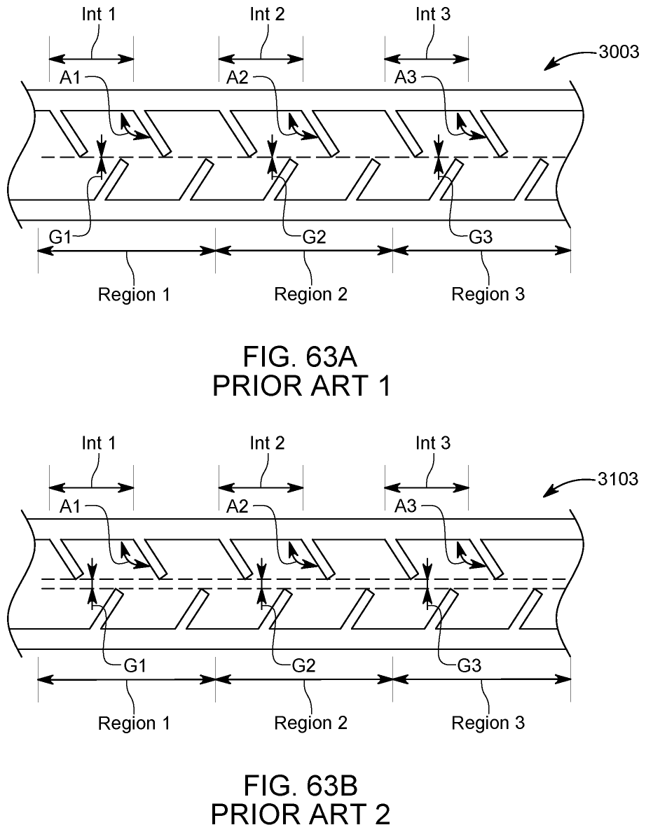

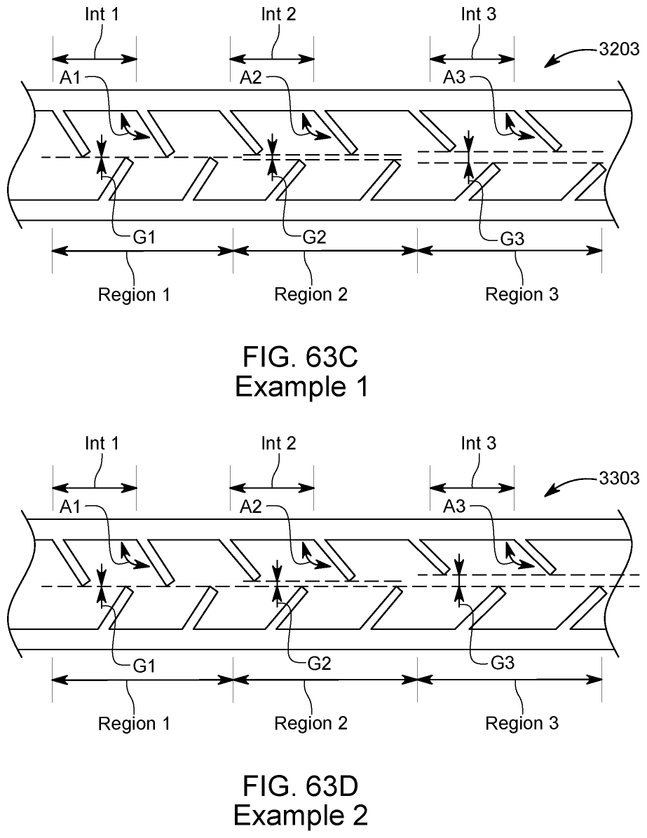

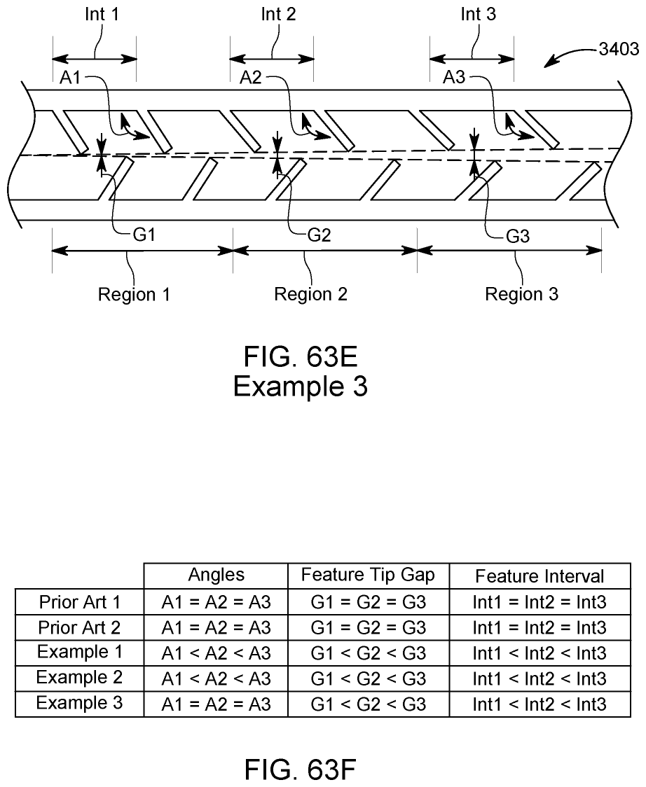

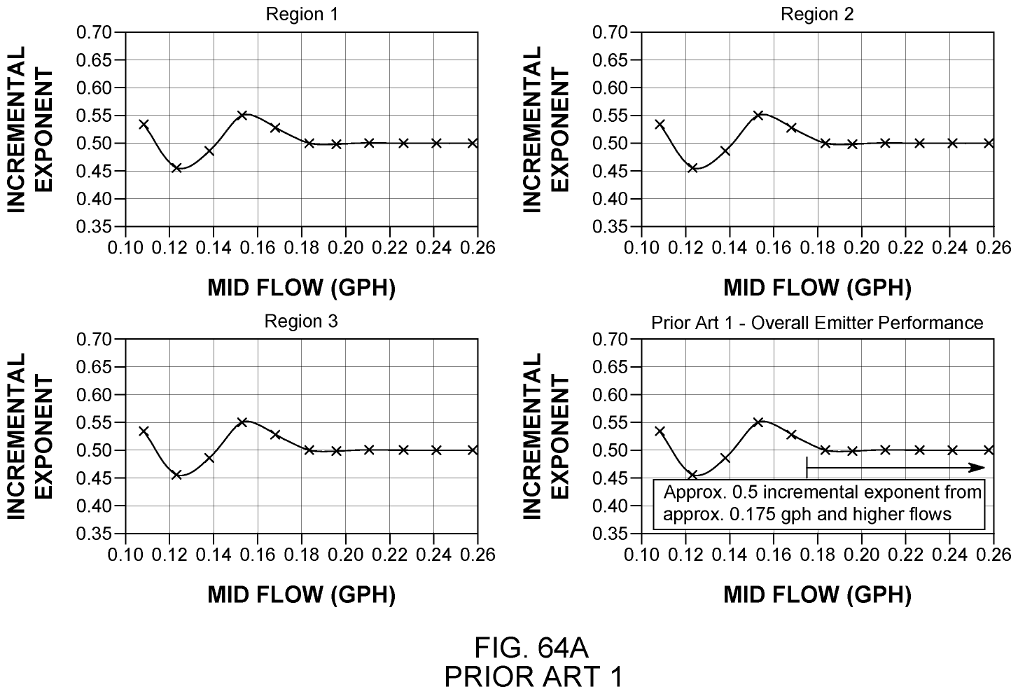

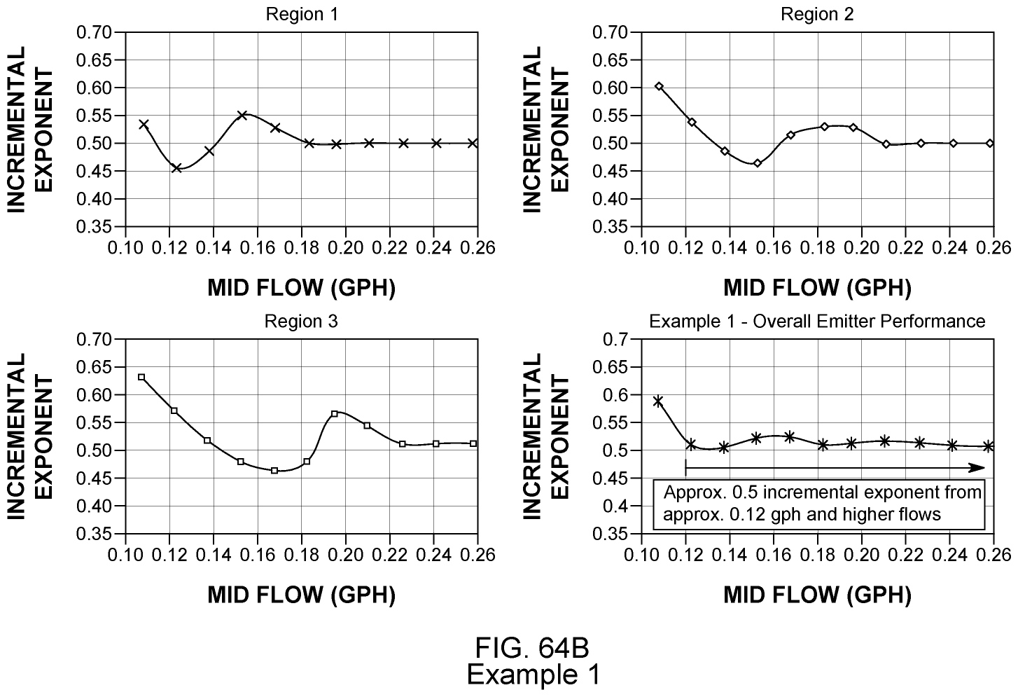

FIGS. 63A-63F illustrate pressure reducing sections 3003 and 3103 of prior art emitters (FIGS. 63A and 63B) compared to pressure reducing sections 3203, 3303, and 3403 of example emitters of the present invention (FIGS. 63C, 63D, and 63E), and the relationships among various angles (A1, A2, and A3), feature tip gaps (G1, G2, and G3), and feature intervals (Int1, Int2, Int3) among the sections illustrated are shown in FIG. 63F. Although the angles, feature tip gaps, and feature intervals have similar numbers among the different examples, they are not the same, as illustrated in the figures. The lower right hand graphs within FIGS. 64A and 64B illustrate that the example emitter of the present invention has a flatter mid flow versus incremental exponent. For the prior art emitter illustrated in FIG. 63A, the mid flow versus the incremental exponent for each of three regions is shown along with the overall emitter performance in FIG. 64A. Because the geometry of the prior art is similar and recurring throughout its length, the relationship between incremental exponent and flow rate is the same for each of the three regions and is the same as the overall emitter performance. For an example emitter illustrated in FIG. 63C, the mid flow versus the incremental exponent for each of three regions is shown along with the overall emitter performance in FIG. 64B. Because the geometry within each depicted region differs with regard to feature interval, feature angle, and feature tip relationship to centerline (or gap to each other), the relationship between incremental exponent and flow differs. This can be seen by representation charts showing incremental exponent versus mid flow rate for each of the three depicted regions. Because the overall emitter performance is defined by the combination of the individual regions, the overall emitter incremental exponent versus mid flow can be modified. Generally, by selecting geometries with curves portrayed for region 1, region 2, and region 3, the behaviors for each region can be selected such that when one region is transitioning below 0.5 in exponent for a given flow, a different region can be moving upward above 0.5 at the given flow rate such that the net influence is to flatten the overall curve with regard to incremental exponent versus overall flow range. Observing the overall emitter performance curve for the example emitter of the invention and comparing with the overall emitter performance curve for the prior art example, we can see the broader flow range over which the incremental exponent is comparatively flat for the invention example from 0.12 gph upward, while prior art example is comparatively flat from 0.175 gph and upward. These examples are simplified for the sake of illustration. In actual practice, as illustrated in FIG. 22 for example, there are a relatively large quantity of geometric relationships which can be utilized to establish a relationship between incremental exponent and flow. As suggested herein, with as little as differing regions within the emitter, it is possible for the behavior of one region to offset the other region to flatten the overall curve. Additionally, for most emitters, there are a high number of features used to dissipate the applied pressure. By using a high number of features, the clearances for each feature can be greater and clogging resistance improved. This is an added benefit as the current invention is not focusing specifically on clogging resistance. With a high number of features in a typical emitter, this invention can modify the features to have a high number of different incremental exponent versus mid flow relationships in order to either extend (make broader) the flow range with consistent exponent or to further diminish the small perturbations away from flat relations between flow and incremental exponent.

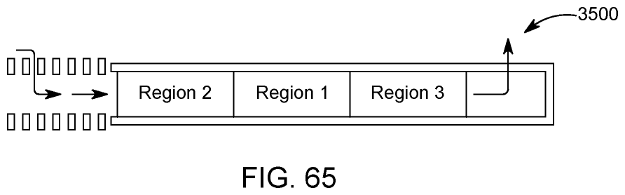

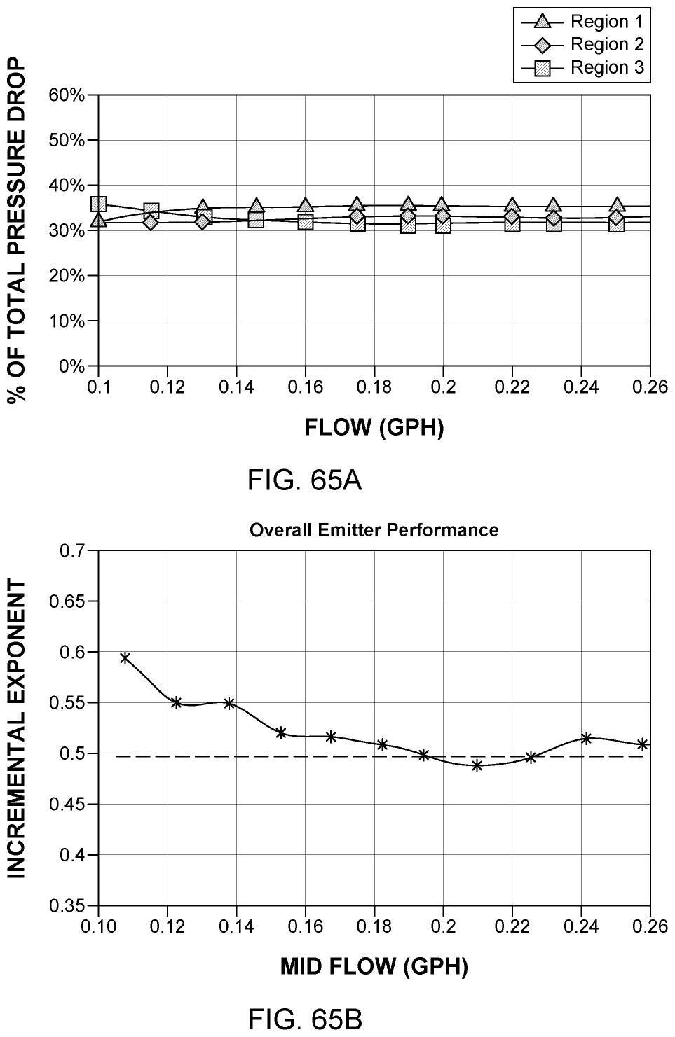

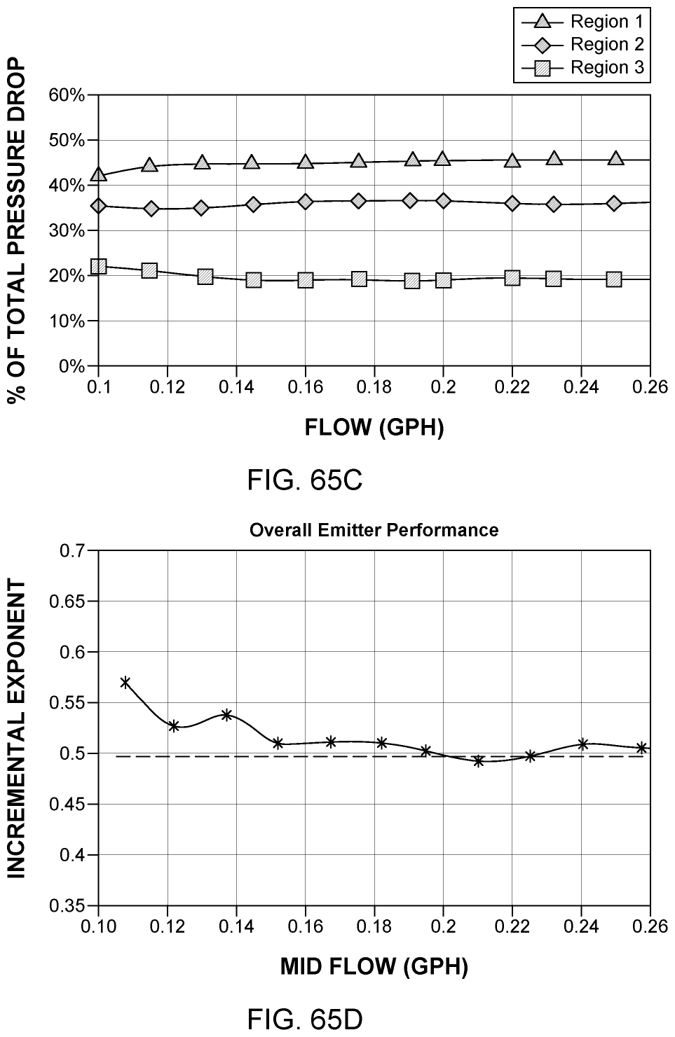

Another example emitter 3500 with three regions is generally illustrated in FIG. 65. Each of the three regions has geometry differing from each other with regard to the flows at which transition occurs. FIG. 65A illustrates that the contribution to the overall pressure drop is comparable for each of the three regions (each contributing approximately ⅓ of the total overall pressure drop). FIG. 65B illustrates an example of the incremental exponent versus flow when using pressure drop contributions depicted in FIG. 65A. Alternatively, as depicted in FIGS. 65C and 65D, by adjusting the comparative pressure drop construction for a given geometry, the overall performance can be further optimized, as seen by comparing FIG. 65B and 65D. In other words, by using geometries with differing flows at which transition occurs, you can optimize (make flatter) the relationship between incremental exponent and flow, however, further yet improvement can be made as part of this invention by tuning the comparative contribution of each region by adjusting the percentage total pressure drop. This is a simplified explanation for illustration purposes in as much as there is no limitation on the number of differing geometries and/or differing regions that can be used to further optimize the emitter.

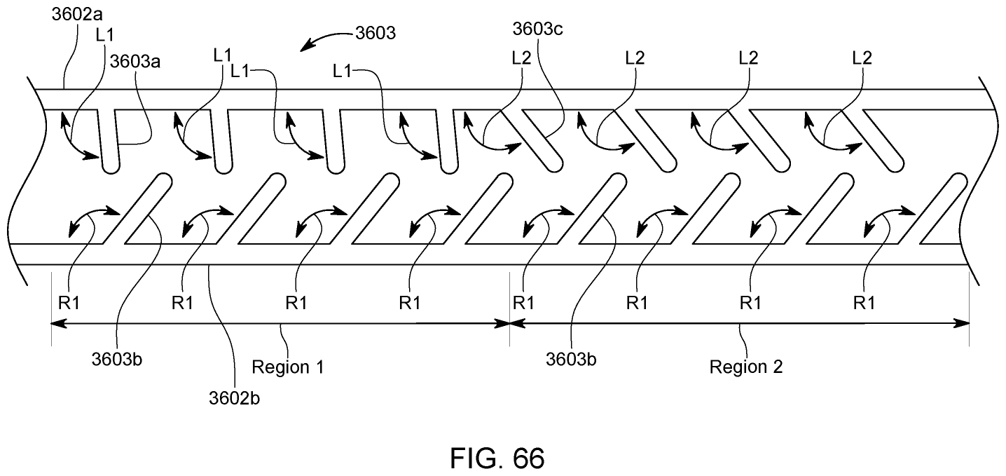

As illustrated in FIG. 66, another example pressure reducing section 3603 includes a rail section 3602a from which features 3603a and 3603c extend and a rail section 3602b from which features 3603b extend. In this example, there are two regions. In Region 1, features 3603a form angle L1 with the rail section 3602a; in Region 2, features 3603c form angle L2 with the rail section 3602a; and features 3603b form angle R1 with the rail section 3602b in both regions.

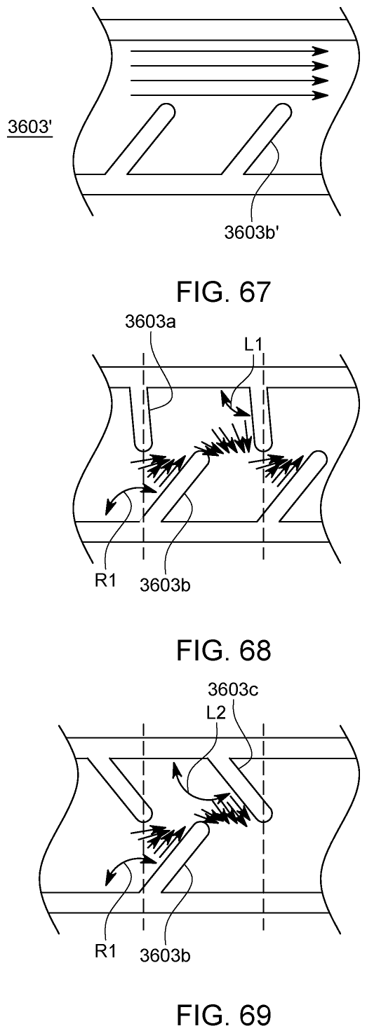

FIG. 67 is included to illustrate contrast with FIG. 68 (Region 1) and FIG. 69 (Region 2) of FIG. 66. FIG. 67 notionally depicts “straight through flow” in contrast with FIGS. 68 and 69 to illustrate how opposing features, extending from opposing rails, create alternating contractions and expansions by which a majority of pressure drop is generated within drip irrigation emitter pressure reducing sections. FIG. 68 illustrates how in contraction portions the flow of water notionally occurs when feature couplets of features with angle R1 are paired with opposing features with angle L1. FIG. 69 illustrates how in contraction portions the flow of water notionally occurs when a feature couplet of features with angle R1 are paired with opposing features with angle L2. In contrasting FIGS. 68 and 69, the flow contraction characteristics differ for pair couplets in FIG. 68 inclusive of features with angle L1 coupled with features with angle R1 (L1-R1 feature couplet), as opposed to FIG. 69 inclusive of feature with angle L2 coupled with features with angle R1 (L2-R1 feature couplet). For this reason, the incremental exponent versus flow performance is different for a pressure reducing section including L1-R1 feature couplets, and a pressure reducing section including L2-R1 feature couplets. For this reason, the pressure reducing section regions 1 and 2 within FIG. 66 behave differently, and thus the overall combined incremental exponent versus flow behavior for an emitter with a pressure reducing section depicted in FIG. 66 is a combined result of the differing performances of L1-R1 and L2-R1 flow couplet incremental exponents versus flow. Thus, by changing a single geometric tuning feature attribute, related to a single feature within a pressure reducing section (e.g., upstream angle on L1 versus L2 along rail 3602a as in this example), it is possible to utilize the invention of establishing an overall incremental exponent versus flow performance by combining differing incremental exponent versus flow performance characteristics of the two differing couplets created by changing a geometric tuning feature attribute.

In addition, although angles L1 and R1 within Region 1 of FIG. 66 are different, the incremental exponent versus flow performance of each couplet L1-R1 throughout Region 1 is the same. If an entire pressure responsive section was comprised of recurring feature pair couplets L1-R1, the overall pressure responsive section's incremental exponent versus flow behavior would be the same as each of the recurring L1-R1 couplets. Thus, having a different angle for features along one rail than along the opposing rail is not sufficient to accomplish the combining of more than one incremental exponent versus flow behavior. Reiterating what was previously stated, a difference in geometric tuning features attribute between at least two features along the same rail (upstream feature angle L1 versus L2 for the example in FIG. 66) creates two different incremental exponents versus flow behaviors. By tuning the behaviors such that the flow at which one feature couplet (e.g., L1-R1) transitions downward in exponent (lower than 0.5) occurs at or near a flow at which a second feature couplet (L2-R1) remains above 0.5 in exponent can result in an offsetting, or partial offsetting, condition resulting in a more consistent overall emitter incremental exponent versus flow behavior. Further optimization can occur by utilizing more than two occurrences of geometric differing tuning feature elements, however, differences between at least two features along a single rail is sufficient to be a benefit. FIG. 22 along with other figures described herein offer additional examples of tuning attributes that can be used for features.

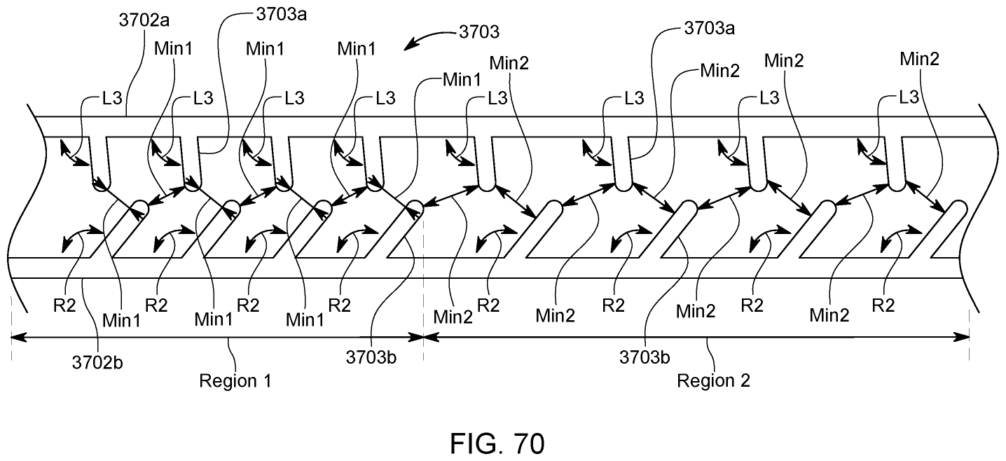

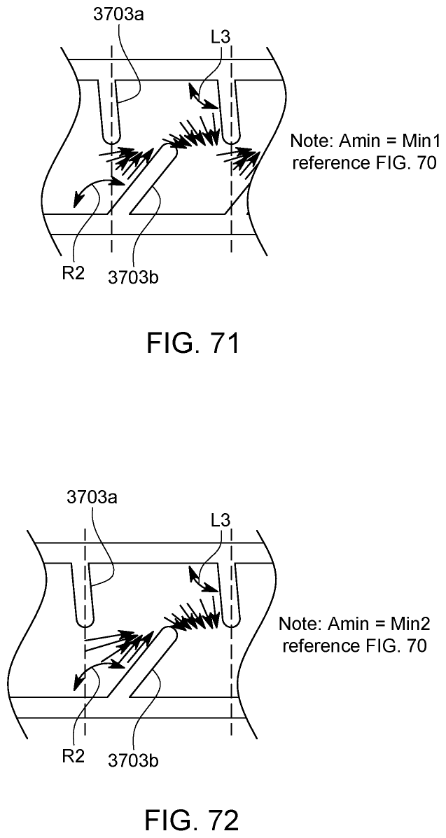

As illustrated in FIG. 70, another example pressure reducing section 3703 includes a rail section 3702a from which features 3703a extend and a rail section 3702b from which features 3703b extend. In this example, there are two regions. In Region 1, features 3703a form angle L3 with the rail section 3702a and adjacent features 3703a having a first spacing; in Region 2, features 3703a form angle L3 with the rail section 3702a and adjacent features 3703a have a second spacing that is further apart than the first spacing; and features 3703b form angle R2 with the rail section 3702b in both regions. Although individual feature tuning attributes do not change (L3 and R2 are constant along with other feature attributes) along the length of the pressure reducing section, however, the dimensional relationship between opposing features is not constant. More specifically, Region 1 has an Amin dimension (Min1) between opposing features that differs from an Amin dimension (Min2) between opposing features within Region 2. FIG. 71 illustrates how the contraction portions flow of water notionally occurs when a feature couplet of features 3703a and 3703b with Min1 in Region 1 of FIG. 70. FIG. 72 illustrates how the contraction portions flow of water notionally occurs when a feature couplet of features 3703a and 3703b with Min2 in Region 2 of FIG. 70.

Contrasting FIGS. 71 and 72, the flow contraction characteristics differ for Region 1 and Region 2 of FIG. 70 (Region 1 pair couplets in FIG. 71 (L3-R2 with Amin=Min1) versus Region 2 couplets in FIG. 72 (L3-R2 with Amin=Min2)). Because of the differences between Min1 and Min2, the incremental exponent versus flow performance is different for Region 1 and Region 2 and the overall combined incremental exponent versus flow behavior for emitter pressure reducing section illustrated with FIG. 70 is a combined result of the differing performance of Min1 and Min2 incremental exponent versus flow behaviors. Thus, by changing a single dimensional relationship between pressure reducing section features (e.g., Amin in this example), it is possible to utilize the invention of establishing an overall incremental exponent versus flow performance by combining differing incremental exponent versus flow performance characteristics of the two regions (wherein the only difference between the two regions is a single dimensional relationship, Amin). By selecting Min1 and Min2, corresponding to the single dimensional relationship differing between Region 1 and Region 2, to be such that the flow at which one region transitions downward in exponent (lower than 0.5) at or near a flow at the second region that remains above 0.5 in exponent can result in an offsetting, or partial offsetting, condition resulting in a more consistent overall emitter incremental exponent versus flow behavior. Further optimization can occur by utilizing more than one differing dimensional relationship occurrence, however, at least one dimensional relationship difference between features is sufficient to be a benefit. Note, Amin relates to dimensional relationship between features on opposing rails, however, some dimensional relationships, such as Amax relate to the dimensions between only one feature and a different geometric element within the emitter. Examples include Amax with distances from one feature tip and the opposing rail inner wall. An additional example includes a positional relationship of tip to centerline, where the distance from a single feature tip to the centerline of the pressure reducing section is a tuning feature to modify incremental exponent versus flow behavior. FIG. 22 along with other figures described herein offer additional examples of tuning attributes that can be used for features. Therefore, it is possible with a difference in a single dimensional relationship between at least one feature and at least one other emitter element to create at least two different incremental exponent versus flow behaviors, and to shift the overall combined incremental exponent versus flow performance.

It is understood that any suitable geometry/geometries can be used for the features in any embodiment. For example, a geometry shown in one example embodiment can be used with another geometry shown in another example embodiment. In addition, the features can be rigid non-pressure responsive or pressure responsive features. Features are chosen to hydraulically tune with varying hydraulic transitioning flows thereby achieving a desired incremental exponent over each portion of the flow versus pressure relationship. In addition, although example regions of features in example pressure reducing sections are illustrated, it is recognized that any number of suitable regions of features could be used.

Prior art has not included combining specific differing geometries, such that each of the geometries was designed to superimpose the hydraulic transition behaviors in a manner to flatten the exponent behavior to be consistent over each increment of the operating range. When prior art feature geometry is identified as optimized in performance, the emitters utilize the geometry in a repeating fashion within the emitter in order to take benefit of the optimized performance. Said differently, if for example a geometry is optimized to provide the highest resistance to flow per lineal length, that optimized geometry is used as a repeating pattern within the emitter. Additionally, for injection molded emitters, there is a production need to have uniform walls and patterns within the design in order to avoid distortion or localized sinking. Similarly, for continuous formation processes, the need to balance the rotary molds to have similar mass needed per linear distance leads to geometry being used in a repeating pattern. These factors have lead historically to emitter designs with repeating overall patterns of resistance within the overall emitter. The present invention, specifically and intentionally optimizes the use of different patterns of resistance features in order to optimize the consistency of the emitter exponent versus flow relationship. Through using solid modeling as part of the emitter design supported by flow analysis/testing, it is possible to identify how to vary the feature geometry while maintaining permissible minor variations in feature dimensions, without impacting the average material per unit length for a continuous process or without impacting inject molding limitations. Said differently, the dimensions used within drip irrigation emitters are small enough (differences on the order of 0.0005 to 0.001 inch are enough to shift performance) that it is possible for the current invention to tailor the incremental exponent performance of sets of features while respecting manufacturing limitations.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An emitter, comprising:
a floor, a first rail, and a second rail defining at least one pressure reducing section interconnecting an inlet section and an outlet section, the at least one pressure reducing section including first opposing features in a first region configured and arranged to provide a first incremental exponent versus flow rate behavior and second opposing features in a second region configured and arranged to provide a second incremental exponent versus flow rate behavior, the first incremental exponent versus flow rate behavior being different than the second incremental exponent versus flow rate behavior, the first and second incremental exponent versus flow rate behaviors providing a more consistent overall incremental exponent versus flow rate behavior over a pressure range.

2. The emitter of claim 1, wherein the first and second regions provide an overall incremental exponent versus flow rate of 0.45 to 0.55.

3. The emitter of claim 1, wherein the floor, the first rail, and the second rail define at least one pressure responsive section interconnecting a first pressure reducing section of the at least one pressure reducing section and one of the inlet section or the outlet section.

4. The emitter of claim 3, further comprising a second pressure reducing section interconnecting the at least one pressure responsive section and the one of the inlet section or the outlet section.

5. The emitter of claim 1, wherein the first and second rails are operatively connected to a lateral having a lateral wall.

6. The emitter of claim 5, wherein the emitter is operatively connected to the lateral wall encircled to form a drip irrigation lateral selected from the group consisting of an overlapping wall lateral, a seamless wall lateral, and a seamed wall lateral.

7. The emitter of claim 6, wherein the lateral wall is made of at least one layer including at least one material, the at least one material selected from the group consisting of an elastomeric material, a non-elastomeric material, and a combination thereof.

8. The emitter of claim 1, wherein the emitter is made of at least one layer including at least one material, the at least one material selected from the group consisting of an elastomeric material, a non-elastomeric material, and a combination thereof.

9. The emitter of claim 1, wherein the first rail, the second rail, the first opposing features, and the second opposing features are rigid.

10. The emitter of claim 1, wherein at least one of the first and second opposing features include varying geometries selected from the group consisting of tip position relative to a center line, feature angle upstream surface, feature included angle, feature angle downstream surface, alternating angles, Amin dimension, Amax dimension, alternating Amax, alternating Amin, floor thickness, rail height, rail width, tip configuration, tip end angle, tip sharpness, tip extension, floor feature, wall deflection, internal radius, feature draft, feature surface linearity, feature direction, flow field feature, feature interval, inner rail separation, and rail surface.

11. The emitter of claim 10, wherein the varying geometries include asymmetrical opposing sides.

12. The emitter of claim 10, wherein the varying geometries vary in a manner from the group consisting of a series of successive increments, a progression of changes, alternating changes, and interspersed changes along at least one pressure reducing section.

13. The emitter of claim 1, wherein at least one of the first and second opposing features vary in position relative to a centerline of the at least one pressure reducing section.

14. The emitter of claim 1, wherein at least one feature of at least one of the first and second opposing features includes a flow field feature.

15. The emitter of claim 1, wherein the floor includes at least one of a downward feature and/or an upward feature.

16. The emitter of claim 1, wherein at least a portion of at least one of the features is defined by a geometry of at least one of the first and second rails.

17. An irrigation lateral, comprising:
a lateral having a wall with an inner wall, at least a portion of the inner wall defining a lateral flow path;
an emitter having a first rail and a second rail operatively connected to the inner wall and a floor interconnecting distal ends of the first and second rails, the inner wall, the first and second rails, and the floor defining an emitter flow path, the emitter comprising:
a floor, a first rail, and a second rail defining at least one pressure reducing section interconnecting an inlet section and an outlet section, the at least one pressure reducing section including first opposing features in a first region configured and arranged to provide a first incremental exponent versus flow rate behavior and second opposing features in a second region configured and arranged to provide a second incremental exponent versus flow rate behavior, the first incremental exponent versus flow rate behavior being different than the second incremental exponent versus flow rate behavior, the first and second incremental exponent versus flow rate behaviors providing a more consistent overall incremental exponent versus flow rate behavior over a pressure range.

18. The irrigation lateral of claim 17, wherein the first and second regions provide an overall incremental exponent versus flow rate of 0.45 to 0.55.

19. The emitter of claim 17, wherein the floor, the first rail, and the second rail define at least one pressure responsive section interconnecting a first pressure reducing section of the at least one pressure reducing section and one of the inlet section or the outlet section.
